(19) United States
(12) Patent Application Publication
(10) Pub. No.: US 2024/0031893 A1
(43) Pub. Date: Jan. 25, 2024

(54) MANAGING UE CONNECTIONS AFTER NETWORK TOPOLOGY CHANGE

(71) Applicant: GOOGLE LLC, Mountain View, CA (US)

(72) Inventor: Chih-Hsiang Wu, Mountain View, CA (US)

(21) Appl. No.: 18/271,164

(22) PCT Filed: Jan. 5, 2022
(86) PCT No.: PCT/US22/11246

§ 371 Date: Jul. 6, 2023

Related U.S. Application Data
(60) Provisional application No. 63/134,357, filed on Jan. 6, 2021.

(51) Int. Cl. H04W 36/08; H04W 36/00

(52) U.S. Cl. CPC H04W 36/08; H04W 36/0033

(57) ABSTRACT

A source donor, for managing a connection between a user equipment (UE) and a radio access network (RAN) via an integrated access backhaul (IAB)-node, (i) determines (2002), when the IAB-node communicates with the RAN via the source donor, that the IAB-node is to migrate from the source donor to establish a new radio connection with the RAN, and (ii) subsequently to the determining and prior to the UE and the IAB-node establishing respective new connections with the RAN, facilitates (2004) exchange of data between the UE and a core network (CN) via the source donor and the target donor.

### FIELD OF THE DISCLOSURE

This disclosure relates generally to wireless communications and, more particularly, to managing user equipment (UE) connections during or after a network topology change.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, integrated access and backhaul (IAB) enables wireless relaying in a radio access network (RAN). A relaying node, referred to as an IAB-node, supports access and backhauling via New Radio (NR). The terminating node of NR backhauling on the network side is referred to as the IAB-donor, which represents a base station with additional functionality to support IAB. Backhauling can occur via a single hop or via multiple hops, so that a user equipment (UE) communicates with the RAN via one IAB-node, or two or more IAB-nodes, and an IAB-donor. The IAB-donor provides network access to UEs via a system of backhaul and access links.

An IAB-donor can implement distributed architecture and include an IAB-donor-CU and one or more IAB-donor-DUs. In a 5G network architecture, the IAB-donor-CU is the gNB-CU of an IAB-donor, terminating the F1 interface with IAB-nodes and IAB-donor-DU. The IAB-donor-DU can be the gNB-DU of an IAB-donor. The IAB-donor-DU can host an IAB BAP sublayer (as defined in TS 38.340 Backhaul Adaptation Protocol (BAP), v. 16.2.0), providing wireless backhaul to IAB-nodes.

An IAB-node is a RAN node that can support NR access links to UEs and NR backhaul links to parent node(s) and child node(s). The parent node can be an IAB-node or an IAB-donor, and the child node is an IAB-node. The IAB-node supports gNB-DU functionality, as defined in TS 38.401 v. 15.5.0, to terminate the NR access interface to UEs and next-hop IAB-nodes, and to terminate the F1 protocol to the gNB-CU functionality, as defined in TS 38.401, at the IAB-donor. The gNB-DU functionality at the IAB-node is also referred to as IAB-DU. An IAB node routes IP traffic of an IAB-DU over the wireless backhaul via the BAP sublayer. In addition to the gNB-DU functionality, the IAB-node also supports a subset of the UE functionality referred to as IAB mobile terminal (IAB-MT). This functionality includes, for example, physical layer, layer-2, RRC, and NAS functionality to connect to the gNB-DU of another IAB-node or the IAB-donor, to connect to the gNB-CU of the IAB-donor, and to the core network (CN). The IAB-MT can correspond to IAB-UE functionality.

All IAB-nodes that are connected to an IAB-donor via one or multiple hops form a directed acyclic graph (DAG) topology with the IAB-donor at the root. According to this DAG topology, the neighbor node on the interface of the IAB-DU is referred to as child node, and the neighbor node on the interface of the IAB-MT is referred to as parent node. The direction toward the child node is referred to as downstream, while the direction toward the parent node is referred to as upstream. The IAB-donor performs centralized resource, topology, and route management for the DAG topology.

For backhaul transport in IAB, the IAB-node routes IP traffic of the IAB-DU over the wireless backhaul, via the BAP sublayer. The BAP sublayer is specified in TS 38.340 v. 16.1.0. In the downstream direction, the BAP sublayer encapsulates upper-layer packets of the IAB-donor-DU and de-encapsulates the packets at the destination IAB-node. In the upstream direction, the BAP layer encapsulates upper-layer packets at the IAB-node and de-encapsulates the packets at the IAB-donor-DU. IAB-specific transport between IAB-donor-CU and IAB-donor-DU is specified in TS 38.401. The BAP sublayer routes packets based on the BAP routing ID in the BAP header. The communication stack adds the BAP header to the packet when the packet arrives from upper layers, and removes the BAP header when the packet has reached its destination node. The IAB-donor-CU selects and configures a BAP routing ID for a packet. The BAP routing ID consists of BAP address and BAP path ID, where the BAP address indicates the destination node of the packet on the BAP sublayer, and the BAP path ID indicates the routing path the packet should follow to this destination. To support routing, each IAB-node and IAB-donor-DU has a respective designated BAP address.

There are several types of UE associations in an NG-RAN node. The NG-RAN node UE context stores all information needed for a UE and the associations between the UE and the logical NG and Xn connections used for NG/XnAP UE associated messages. The NG-RAN node UE context is a block of information in an NG-RAN node associated with one UE when the UE is in the CM CONNECTED state. This block of information contains the information required to maintain the NG-RAN services for the active UE. An NG-RAN node establishes an NG-RAN node UE context when the UE completes the transition to the RRC CONNECTED state, after completion of handover resource allocation during handover preparation. In the latter case, at least UE state information, security information, UE capability information, and the identities of the UE-associated logical NG-connection are included in the NG-RAN node UE context. For dual connectivity, an S-NG-RAN establishes an NG-RAN node UE context after completion of an S-NG-RAN node Addition Preparation procedure. If a UE Context setup or modification procedure involves set up of radio bearers, the UE capabilities are provided to the receiving node as part of the UE context setup or modification procedures.

A bearer context is a block of information in a gNB-CU-UP node associated with one UE. The bearer context is used for communication over the E1 interface. The bearer context may include information about data radio bearers, PDU sessions and QoS-flows associated with the UE. The block of information contains the information required to maintain user-plane services for the UE.

Further, UE-associated logical NG/Xn/F1/E1-connection NGAP, XnAP, F1AP, and E1AP provide means to exchange control plane messages associated with the UE over the NG-C, Xn-C, and F1-Cinterfaces, respectively. A UE-associated logical connection is established during the first NGAP/XnAP/F1AP message exchange between the NG/Xn/F1 peer nodes. The network maintains the connection as long as nodes need to exchange UE-associated NG/XnAP/F1AP messages over the NG/Xn/F1 interface. The UE-associated logical NG-connection uses the identities AMF UE NGAP ID and RAN UE NGAP ID. The UE-associated logical Xn-connection uses the identities Old NG-RAN node UE XnAP ID and New NG-RAN node UE XnAP ID, or M-NG-RAN node UE XnAP ID and S-NG-RAN node UE XnAP ID. The UE-associated logical F1-connection uses the identities gNB-CU UE F1AP ID and gNB-DU UE F1AP ID. When a node (AMF or gNB) receives a UE associated NGAP/XnAP/F1AP message the node retrieves the associated UE based on the NGAP/XnAP/F1AP ID.

In topology adaptation scenarios, the IAB-node may need to migrate (e.g., handover) from one parent node to another parent node to continue communicating with the RAN. When the IAB-node requires inter-donor migration (i.e., from one donor to another), it is not clear how IAB nodes and donor should support the signalling, manage context, and modify the topology. For instance, it is not clear how the source donor or a target donor should handle failures which the IAB-node can encounter on the radio link with the source donor, during inter-donor migration.

### BRIEF DESCRIPTION OF THE DRAWINGS

FIG. 1A is a block diagram of an example system in which a radio access network (RAN) supports IAB topology and can implement the techniques of this disclosure for managing inter-donor migration;

FIG. 1B is a block diagram of an example base station with a centralized unit (CU) and a distributed unit (DU) that can operate in the system of FIG. 1A;

FIGS. 2A and 2B are block diagrams of example protocol stacks according to which the UE or an IAB-MT of FIG. 1A communicates with base stations;

FIG. 3 is a block diagram of an example NG RAN supporting TAB;

FIG. 4A is a block diagram of an example protocol stack of the NG RAN supporting TAB for the user plane;

FIG. 4B is a block diagram of an example protocol stack of the NG RAN supporting IAB for the control plane;

FIG. 4C is a block diagram of an example protocol stack of the NG RAN supporting TAB for delivering IAB control plane traffic via a master eNodeB (MeNB);

FIG. 5 is a messaging diagram of an example scenario in which an IAB-node, after detecting a radio link failure with the S-IAB-donor, initiates an RRC procedure to establish a connection to a target IAB-donor, followed by a UE handover procedure;

FIG. 6 is a messaging diagram of an example scenario in which an IAB-node, after detecting a radio link failure, initiates an RRC reestablishment procedure to establish a connection to a target IAB-donor, followed by an RRC reestablishment procedure for the UE;

FIG. 7 is a messaging diagram of an example scenario in which source donor initiates a UE handover procedure to migrate the UE to the target donor, followed by an RRC reestablishment procedure for the IAB-node;

FIG. 8 is a messaging diagram of an example scenario in which source donor initiates a UE handover procedure to migrate the UE to the target donor, the IAB-node performs an RRC reestablishment procedure with the source donor, and the target donor initiates another UE handover procedure to migrate the UE back to the source donor;

FIG. 9 is a messaging diagram of an example scenario in which source donor initiates a UE handover procedure to migrate the UE to the (first) target donor, the IAB-node performs an RRC reestablishment procedure with another (second) target donor, and the first target donor initiates another UE handover procedure to migrate the UE to the second target donor;

FIG. 10 is a messaging diagram of a scenario similar to that of FIG. 9, but with the first target donor transmitting a handover request related to the second target donor to the source donor;

FIG. 11 is a flow diagram of an example method that includes transmitting encrypted data to a UE via a target IAB-donor and an IAB-node during inter-donor migration, which can be implemented in a source IAB-donor of FIG. 1A or FIG. 1B;

FIG. 12 is a flow diagram of an example method that includes forwarding encrypted DL data received from a source IAB-donor to a UE via an IAB-node during inter-donor migration, which can be implemented in a target IAB-donor of FIG. 1A or FIG. 1B;

FIG. 13 is a flow diagram of an example method that includes determining whether to apply PDCP to a DL data packet when transmitting data to a UE via a target IAB-donor and an IAB-node during inter-donor migration during inter-donor migration, which can be implemented in a source IAB-donor of FIG. 1A or FIG. 1B;

FIG. 14 is a flow diagram of an example method that includes forwarding encrypted UL data received from a UE via an IAB-node to a source IAB-donor during inter-donor migration, which can be implemented in a target IAB-donor of FIG. 1A or FIG. 1B;

FIG. 15 is a flow diagram of an example method that includes determining whether to forward an encrypted UL data packet to a source IAB-donor or process the encrypted UL data packet after receiving the encrypted UL data from a UE via an IAB-node during inter-donor migration, which can be implemented in a target IAB-donor of FIG. 1A or FIG. 1B;

FIG. 16 is a flow diagram of an example method for communicating with a UE during inter-donor migration, which can be implemented in a RAN of FIG. 1A;

FIG. 17 is a flow diagram of an example method for communicating with a UE via an IAB-node after the UE hands over from a source IAB-donor to the target IAB-donor during inter-donor migration, which can be implemented in a target IAB-donor of FIG. 1A or FIG. 1B;

FIG. 18 is a flow diagram of an example method for performing handover procedures to hand over a UE to a target IAB-donor, and then hand over the UE back to a source IAB-donor during inter-donor migration, which can be implemented in a RAN of FIG. 1A;

FIG. 19 is a flow diagram of an example method for performing handover procedures to hand over a UE to a first target IAB-donor, and then hand over the UE to a second target IAB-donor during inter-donor migration, which can be implemented in a RAN of FIG. 1A;

FIG. 20 is a flow diagram of an example method for managing a connection between a UE and a RAN via an IAB-node, which can be implemented in a source IAB-donor of FIG. 1A or FIG. 1B; and

FIG. 21 is a flow diagram of an example method for managing a connection between a UE and a RAN via an IAB-node, which can be implemented in a target IAB-donor of FIG. 1A or FIG. 1B.

### DETAILED DESCRIPTION OF THE DRAWINGS

Using the techniques of this disclosure, an IAB-node and a UE in communication with the IAB node can perform inter-donor migration from a source IAB-donor (or just “source donor”) to a target IAB-donor (or just “target donor”) and reduce the interruptions in transferring data between the UE and the core network (CN).

In some scenarios, the IAB-node triggers inter-donor migration of the IAB-node and the UE upon detecting a radio link failure (RLF) or another type of failure. In other scenarios, the source donor triggers inter-donor migration of the IAB-node and the UE in view of signal measurements at the IAB-node and/or the source donor.

During the inter-donor migration, the source donor can facilitate exchange of data packets by encrypting downlink (DL) data for the UE and transmitting the encrypted DL data to the IAB-node via the target donor, when the transfer of context for the IAB donor completes first (i.e., before the transfer of context for the UE). In another implementations or scenarios, the source donor can forward DL data encrypted at the target donor to the IAB node, when the transfer of context for the UE completes first.

One example embodiment of these techniques is a method implemented in a source donor. The method can be executed by processing hardware and includes determining, when an IAB-node communicates with a RAN via the source donor, that the IAB-node is to migrate from the source donor to establish a new radio connection with the RAN; and subsequently to the determining and prior to the UE and the IAB-node establishing respective new connections with the RAN, facilitating exchange of data between the UE and a CN via the source donor and a target donor. Another example embodiment of these techniques is a source donor including processing hardware configured to execute the method above.

Yet another example embodiment of these techniques is a method in a target donor. The method can be executed by processing hardware and includes performing, when an IAB-node communicates with a RAN via a source donor, a migration procedure for one of the IAB-node or the UE to the target donor; and subsequently to the performing and prior to the other one of the UE or the IAB-node establishing a new connection with the RAN, exchanging data between the UE and a CN via the source donor and the target donor. Still another embodiment of these techniques is a target donor including processing hardware configured to execute the method above.

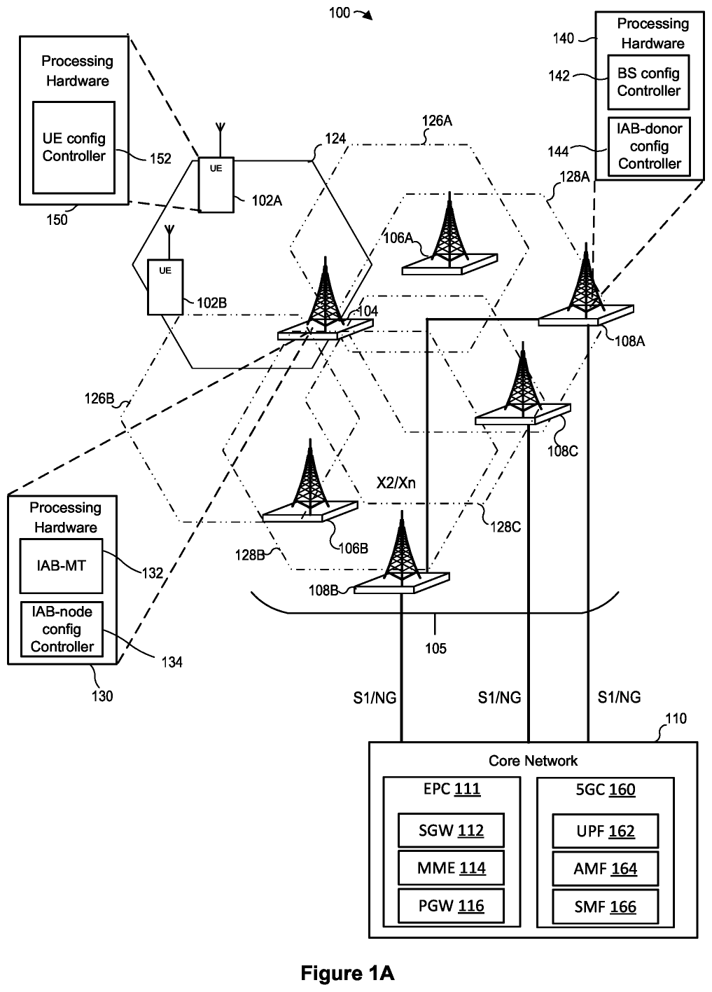

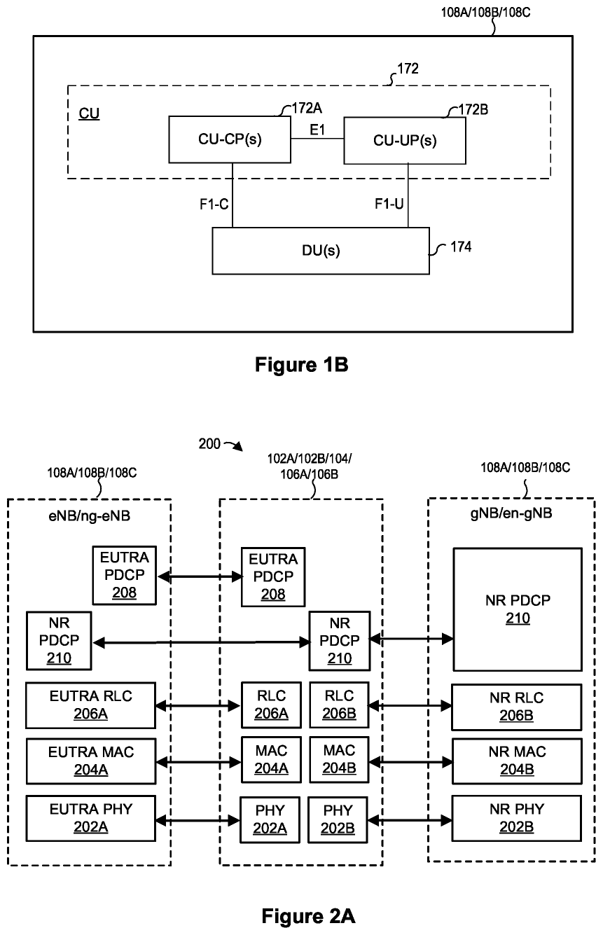

FIG. 1A depicts an example wireless communication system 100 in which communication devices can implement these techniques. The wireless communication system 100 includes UE 102A, UE 102B, a CN 110, and a RAN 105 comprising any one or more of an IAB-node 104, an IAB-node 106A, an IAB-node 106B, an IAB-donor 108A, an IAB-donor 108B, and an IAB-donor 108C. The UE 102A or UE 102B initially connects to the IAB-donor 108A via the IAB-node 104. In some implementations and scenarios, the IAB-node 104 can initially connect to the IAB-donor 108A directly, e.g., over an F1 connection.

In other implementations and scenarios, the IAB-node 104 can connect to the IAB-donor 108A via one or more intermediate IAB-nodes (e.g., IAB-node 106A). In such implementations and scenarios, the IAB-node 104 can establish an F1 connection with the IAB-donor 108A via the one or more intermediate IAB-nodes. Thus, the UE 102A or UE 102B connects to the IAB-donor 108A via the IAB-node 104 and the one or more intermediate IAB-nodes. Throughout the disclosure, the description that UE 102 (e.g., the UE 102A and/or 102B) connects to an IAB-donor 108 (e.g., the IAB-donor 108A, the IAB-donor 108B, or the IAB-donor 108C) via the IAB-node 104 can mean that the UE 102 connects to the IAB-donor via the IAB-node 104, via the IAB-node 104 and the IAB-node 106 (e.g., the IAB-node 106A, IAB-node 106B), or via the IAB-node 104, the IAB-node 106, and the other IAB-node(s). Similarly, the description that the IAB-node 104 connects to the IAB-donor 108 can mean that the IAB-node 104 connects to the IAB-donor 108 directly, via IAB-donor 106, or via the IAB-donor 106 and the other IAB-node(s).

As depicted in FIG. 1A, the IAB-node 104, IAB-node 106A, and IAB-node 106B operate cell 124, 126A, and 126B, respectively, and the IAB-donor 108A, IAB-donor 108B, and IAB-donor 108C operate cell 128A, 128B and 128C respectively. The cells 124, 126A, 126B, 128A, 128B, 128C can partially overlap so that the IAB-node 104 or UE 102 can hand over to the IAB-donor 108B or 108C, or perform an RRC connection reestablishment with the IAB-donor 108B or 108C.

In some scenarios, the IAB-donor 108A can configure the UE 102 (e.g., UE 102A and/or UE 102B) to hand over from the IAB-donor 108A to the IAB-donor 108B due to load-balancing, service robustness, or other reasons, while retaining the connection between the UE 102 and the IAB-node 104. For example, the IAB-donor 108A can send a handover command message to the UE 102 via the IAB-node 104 to hand over the UE 102 to the IAB-donor 108B. In response to the handover command message, the UE hands over to the IAB-donor 108B while still maintaining connection with the IAB-node 104. The inter-donor handover can be an immediate handover or a conditional handover.

In other scenarios, the IAB-donor 108A can configure the IAB-node 104 to hand over from the IAB-donor 108A to the IAB-donor 108B due to load-balancing, service robustness, or based on measurement result(s) (e.g., indicating cell 128B is better suited for the UE 102 than the cell 128A, signal strength/quality of the cell 128B is better than a first threshold, or signal strength/quality of the cell 128A is worse than a second threshold). For example, the IAB-donor 108A can send a handover command message to the IAB-node 104 directly, via the IAB-node 106, or via the IAB-node 106 and other downstream IAB-node(s) to hand over the IAB-node 104 to the IAB-donor 108B. In response to the handover command message, the IAB-node 104 hands over to the IAB-donor 108B. In some implementations, if the handover command message configures the IAB-node 104 to perform handover onto the cell 128B, the IAB-node 104 can perform a random access on the cell 128B with the IAB-donor 108B. In other implementations, if the handover command message configures the IAB-node 104 to perform handover onto the cell 126B, the IAB-node 104 can perform a random access on the cell 126B with the IAB-donor 106B connecting to the IAB-donor 108B. Before handing over to the IAB-donor 108B or performing the random access on the cell 128B or 126B, the IAB-node 104 in some implementations disconnects from the IAB-donor 108A or the cell 128A. In other implementations, the IAB-node 104 maintains connection with the IAB-donor 108A on the cell 128A while and/or after performing the handover with the IAB-donor 108B or the random access on the cell 128B or 126B.

In various configurations of the wireless communication system 100, the UE 102 can communicate with the IAB-node 104 via a first radio access technology (RAT) such as EUTRA or NR, and the IAB-node 104 can communicate with an IAB-donor (e.g., the IAB-donor 108A, 108B, or 108C) or an IAB-node 106A via a second RAT such as EUTRA or NR. The first and second RATs can be the same or different.

In the scenarios where the UE 102 and/or the IAB-node 104 hands over from the IAB-donor 108A to the IAB-donor 108B, the IAB-donors 108A and 108B operate as the source base station (S-BS) and target base station (T-BS), respectively. Similarly, in other scenarios, where the IAB-node 104 detects a failure on a connection with the IAB-donor 108A and performs an RRC connection reestablishment procedure with the IAB-donor 108B, the IAB-donors 108A and 108B operate as the S-BS and T-BS, respectively.

The IAB-donors 108A, 108B, 108C can connect to the same CN 110 which can be an evolved packet core (EPC) 111 or a fifth-generation core (5GC) 160. Each of the IAB-donor 108A, 108B or 108C can be implemented as an eNB supporting an S1 interface for communicating with the EPC 111, an ng-eNB supporting an NG interface for communicating with the 5GC 160, or as a gNB that supports the NR radio interface as well as an NG interface for communicating with the 5GC 160. To directly exchange messages during the scenarios discussed below, the IAB-donors 108A, 108B, 108C can support an X2 or Xn interface (e.g., as shown in FIG. 1A between IAB-donors 108A and 108B).

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE 102 to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

With continued reference to FIG. 1A, the IAB-node 104 includes processing hardware 130, which may include one or more general-purpose processors (e.g., central processing units (CPUs)) and a computer-readable memory storing machine-readable instructions executable on the general-purpose processor(s), and/or special-purpose processing units. The processing hardware 130 in the example implementation of FIG. 1A includes an IAB-mobile terminal (MT) 132 that terminates the Uu interface to a parent node (e.g., IAB-donor 108 or IAB-node 106) using the procedures and behaviors specified for the UE 102. The IAB-MT 132 is configured to manage or control a connection with the IAB-donor 108. In some implementations, the IAB-MT 132 can include a UE configuration controller, similar to a UE configuration controller 152 of the UE 102, to manage or control RRC configurations and/or RRC procedures, e.g., for communication with the IAB-donor 108 on the Uu interface. The processing hardware 130 also includes an IAB-node configuration controller 134 that is configured to manage or control the configuration techniques of this disclosure. For example, the IAB-node configuration controller 134 may be configured to provide and support lower layer configurations for an RRC message for UE 102. In another example, the IAB-node configuration controller 134 is configured to control or manage IAB-node RRC reestablishment and reconfiguration procedures (e.g., including UE context management procedures or F1AP procedures) with the IAB-donor 108. The IAB-nodes 106A, 106B can have processing hardware similar to the IAB-node 104.

The IAB-donor 108A includes processing hardware 140, which may include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes a base station configuration controller 142 that is configured to manage or control RRC procedures and RRC configurations for the connected UE 102 and IAB-MT(s) of IAB node(s) (e.g., the IAB-node 104, 106A, or 106B). For example, the base station configuration controller 142 may be configured to support RRC messaging associated with the handover procedure and/or RRC connection reestablishment procedure. The processing hardware 140 also includes an IAB-donor configuration controller 144 that is configured to manage or control UE context management procedures or F1AP procedures with an IAB-node (e.g., the IAB-node 104, 106A, or 106B). The IAB-donors 108B or 108C can have processing hardware similar to the IAB-donor 108A.

The UE 102 includes processing hardware 150, which may include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes a UE configuration controller 152 that is configured to manage or control RRC procedures and RRC configurations. For example, the configuration controller 152 may be configured to support RRC messaging associated with UE handover procedures and UE RRC reestablishment and reconfiguration procedures in accordance with any of the implementations discussed below.

FIG. 1B depicts an example, distributed implementation of any one or more of the IAB-donors 108A, 108B, or 108C. In this implementation, any one of the IAB-donors 108A, 108B, or 108C includes a centralized unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures. The process hardware can also include a physical layer controller configured to manage or control one or more physical layer operations or procedures.

In some implementations, the CU 172 can include a logical node CU-CP 172A that hosts the control plane (CP) part of the Packet Data Convergence Protocol (PDCP) protocol of the CU 172 and/or radio resource control (RRC) protocol of the CU 172. The CU 172 can also include logical node(s) CU-UP 172B that hosts the user plane (UP) part of the PDCP protocol and/or Service Data Adaptation Protocol (SDAP) protocol of the CU 172.

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C interface. The CU-UP 172B can be connected to one or more DU 174 through the F1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

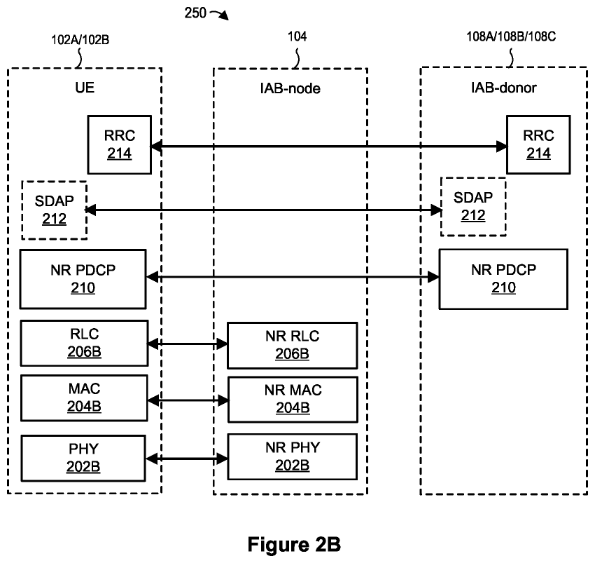

Next, FIG. 2A illustrates in a simplified manner a radio protocol stack 200 according to which the UE 102 can communicate with any of the IAB-donors 108A, 108B, or 108C. Each of the IAB-donors 108A, 108B, or 108C can be the eNB/ng-eNB or the gNB. The IAB-node 104, 106A, or 106B can contain functionalities of the UE 102. As such, the IAB-node 104, 106A, 106B can also use the radio protocol stack 200 to communicate with any of the IAB-donors 108A, 108B, or 108C.

The physical layer (PHY) 202A of EUTRA provides transport channels to the EUTRA Medium Access Control (MAC) sublayer 204A, which in turn provides logical channels to the EUTRA Radio Link Control (RLC) sublayer 206A, and the EUTRA RLC sublayer in turn provides RLC channels to the EUTRA PDCP sublayer 208 and, in some cases, NR PDCP sublayer 210. Similarly, the PHY 202B of NR provides transport channels to the NR MAC sublayer 204B, which in turn provides logical channels to the NR RLC sublayer 206B, and the NR RLC sublayer 206B in turn provides RLC channels to the NR PDCP sublayer 210. The UE 102 in some implementations supports both the EUTRA and the NR stack, to support handover between EUTRA and NR base stations and/or DC over EUTRA and NR interfaces. Further, as illustrated in FIG. 2A, the UE 102 or IAB-MT 132 can support layering of NR PDCP 210 over EUTRA RLC 206A.

The EUTRA PDCP sublayer 208 and the NR PDCP sublayer 210 receive packets (e.g., from the Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 provide SRBs to exchange RRC messages, for example. On a user plane, the EUTRA PDCP sublayer 208 and the NR PDCP sublayer 210 provide DRBs to support data exchange.

When the UE 102 operates in EUTRA/NR DC (EN-DC), with the base station 108A operating as a MeNB and the base station 108B operating as a SgNB, the network can provide the UE 102 or IAB-MT 132 with an MN-terminated bearer that uses EUTRA PDCP 208 or MN-terminated bearer that uses NR PDCP 210. The network in various scenarios also can provide the UE or IAB-MT 132 with an SN-terminated bearer, which use only NR PDCP 210. The MN-terminated bearer can be an MCG bearer or a split bearer. The SN-terminated bearer can be a SCG bearer or a split bearer. The MN-terminated bearer can be an SRB (e.g., SRB1 or SRB2) or a DRB. The SN-terminated bearer can an SRB (e.g., SRB) or a DRB.

In one implementation, the IAB-node 104 generally hosts two NR functions—IAB-MT for maintaining the wireless backhaul connection towards any of the IAB-donors 108A, 108B, or 108C and any intermediate upstream IAB-node (e.g., IAB-node 106A), and IAB-DU for providing access connection via a Uu interface to the UE 102 or downstream MTs of any IAB-nodes. The DU at the IAB-node 104 can connect to a CU hosted by any of the IAB-donors 108A, 108B, or 108C via an F1 interface. Thus, it is possible to functionally split the radio protocol stack, as shown by the radio protocol stack 250 in FIG. 2B. The CU at any of the IAB-donors 108A, 108B, or 108C can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU located at the IAB-node 104. To support connection to a 5GC, NR PDCP 210 provides SRBs to RRC 214, and NR PDCP 210 provides DRBs to SDAP 212 and SRBs to RRC 214.

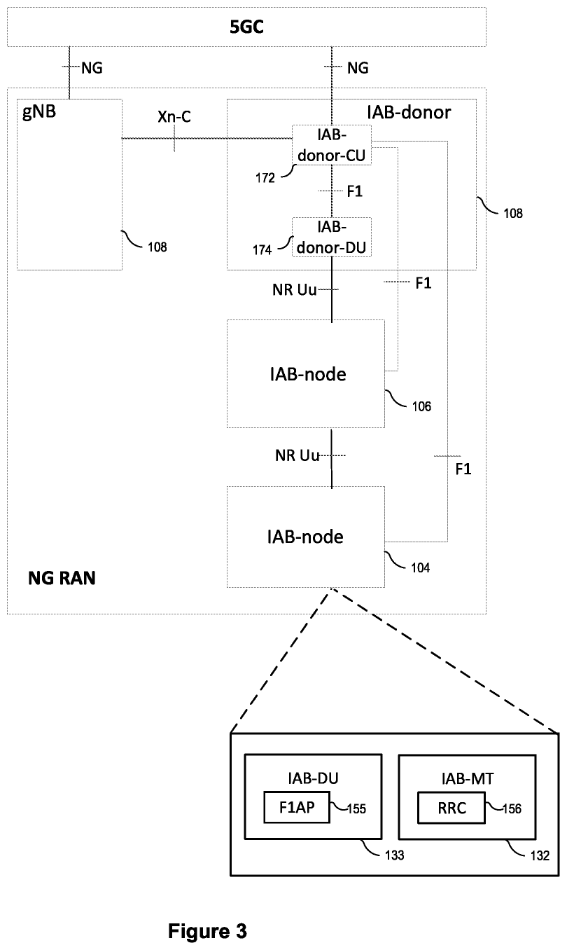

Next, FIG. 3 illustrates an overall topology of an NG-RAN (e.g., RAN 105) supporting IAB as defined in TS 38.401. The NG-RAN supports IAB by the IAB-node 104 and/or IAB-node 106 wirelessly connecting to the IAB-donor 108 that are capable of serving the IAB-node(s) 104 and/or 106.

In some implementations, the IAB-donor 108 has an IAB-donor-CU (e.g., CU 172) and one or more IAB-donor-DU(s) (e.g., DU 174). In some implementations, the IAB-donor-CU can be separated into gNB-CU-CP and gNB-CU-UP. Accordingly, the IAB-donor 108 may have an IAB-donor-CU-CP, multiple IAB-donor-CU-UPs, and multiple IAB-donor-DUs. The IAB-donor-CU 172 terminates the F1 interface towards IAB-node(s) 104 and/or 106 and IAB-donor-DU 174.

The IAB-donor 108 can be a gNB with additional functionality to support IAB. According to 3GPP TS 38.401 and 38.300, a gNB CU (gNB-CU) is a logical node hosting RRC, SDAP, and PDCP protocols of a gNB, or RRC and PDCP protocols of an en-gNB that control the operation of one or more gNB-DUs. The gNB-CU terminates the F1 interface connected with the gNB DU (gNB-DU). The gNB-DU is a logical node hosting RLC, MAC, and PHY layers of the gNB or en-gNB, and its operation is partly controlled by the gNB-CU. One gNB-DU supports one or multiple cells, and each cell is supported by only one gNB-DU. The gNB-DU terminates the F1 interface connected with the gNB-CU.

An IAB-node (e.g., IAB-node 104, IAB-node 106) generally connects to IAB-donor-DU 174 and provides an access connection to the UE 102. As discussed above, an IAB-node (e.g., IAB-node 104) can generally support network functionalities of the NR Uu interface (e.g., via IAB-MT 132) for maintaining the wireless backhaul connection towards IAB-donor-DU 174 and any intermediate upstream IAB-node (e.g., IAB-node 106A) according to RRC protocol 156. The IAB-MT 132 of IAB-node 104 can include, e.g., physical layer, layer-2, RRC, and NAS functionality to connect to the gNB-DU of IAB-node 106, the gNB-CU of the IAB-donor 108, and to the CN 110. The operation of the IAB-MT can be pursuant to TS 23.501. The IAB-node 104 can also generally support a subset of the UE functionalities of the NR Uu interface (e.g., via IAB-DU 133) for providing access connection to the UE 102 or IAB-MTs of any downstream IAB-nodes. The IAB-DU 133 can also enable an IAB-node to connect to IAB-donor-CU 172 using an F1 interface via an F1 Application Protocol (FLAP) 155. F1-C traffic and F1-U traffic between IAB-node 104 and IAB-donor-CU 172 is backhauled via the IAB-donor-DU 174 and the optional intermediate hop IAB-node 106. All functions specified for a gNB-DU are equally applicable for IAB-DU 133 and IAB-donor-DU 174, and all functions specified for a gNB-CU are equally applicable for IAB-donor-CU 172, unless otherwise stated. All functions specified for the UE context are equally applicable for managing the context of IAB-MT 132, unless otherwise stated.

The IAB-donor-DU 174 can host the IAB BAP sublayer (e.g., as defined in TS 38.340 Backhaul Adaptation Protocol (BAP)), providing wireless backhaul to IAB-node(s) 104 and/or 106, e.g., in accordance with TS 38.300. IP traffic from the IAB-DU 133 can be routed over the wireless backhaul via the BAP sublayer. In the downstream direction, upper layer packets are encapsulated by the BAP sublayer at the IAB-donor-DU 174 and de-encapsulated at the destination IAB-node 104. In the upstream direction, upper layer packets are encapsulated at the IAB-node 104 and de-encapsulated at the IAB-donor-DU 174. IAB-specific transport between IAB-donor-CU 172 and IAB-donor-DU 174 can occur in accordance with TS 38.401. On the BAP sublayer, packets are routed based on the BAP routing ID, which is carried in the BAP header. The BAP header is added to the packet when the packet arrives from upper layers, and the BAP header is stripped off when the packet has reached its destination node. The selection of the packet's BAP routing ID is configured by the IAB-donor-CU 172. The BAP routing ID has a BAP address and BAP path ID, where the BAP address indicates the destination node of the packet on the BAP sublayer, and the BAP path ID indicates the routing path the packet should follow to this destination. For the purpose of routing, each IAB-node 104 and/or 106 and IAB-donor-DU 174 is further configured with a designated BAP address.

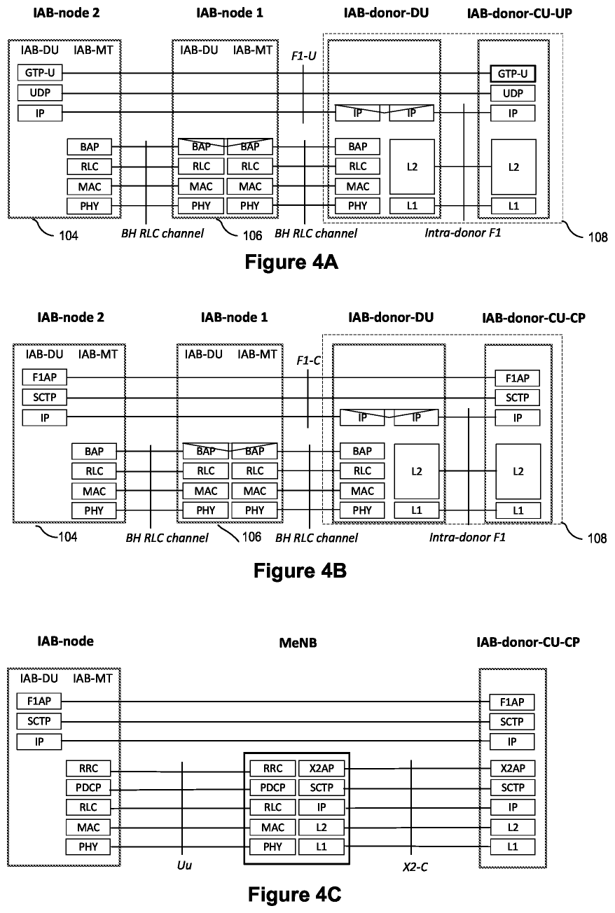

FIGS. 4A, 4B, and 4C illustrate examples of protocol stacks of an NG RAN supporting IAB for the user plane, control plane, and for delivering IAB control plane traffic via an MeNB, e.g., in accordance with TS 38.401. The PHY, MAC, RLC, PDCP, and RRC sublayers described in FIGS. 4A, 4B, and 4C may correspond to those depicted in FIG. 2A or 2B. As described above, in some implementations, the IAB-donor-CU 172 can be separated into gNB-CU-CP and gNB-CU-UP. FIG. 4A shows the protocol stack for F1-U between IAB-DU 133 and the IAB-donor-CU-UP, and FIG. 4B shows the protocol stack for F1-C between IAB-DU 133 and the IAB-donor-CU-CP. In these figures, F1-U and F1-C traffic are carried over two backhaul hops. FIG. 4C shows the protocol stack for F1-C between IAB-DU 133 and the IAB-donor-CU-CP, when the F1-C traffic is transmitted via an MeNB and the IAB-node 104 is in EN-DC with the MeNB and an IAB-donor serving as SgNB.

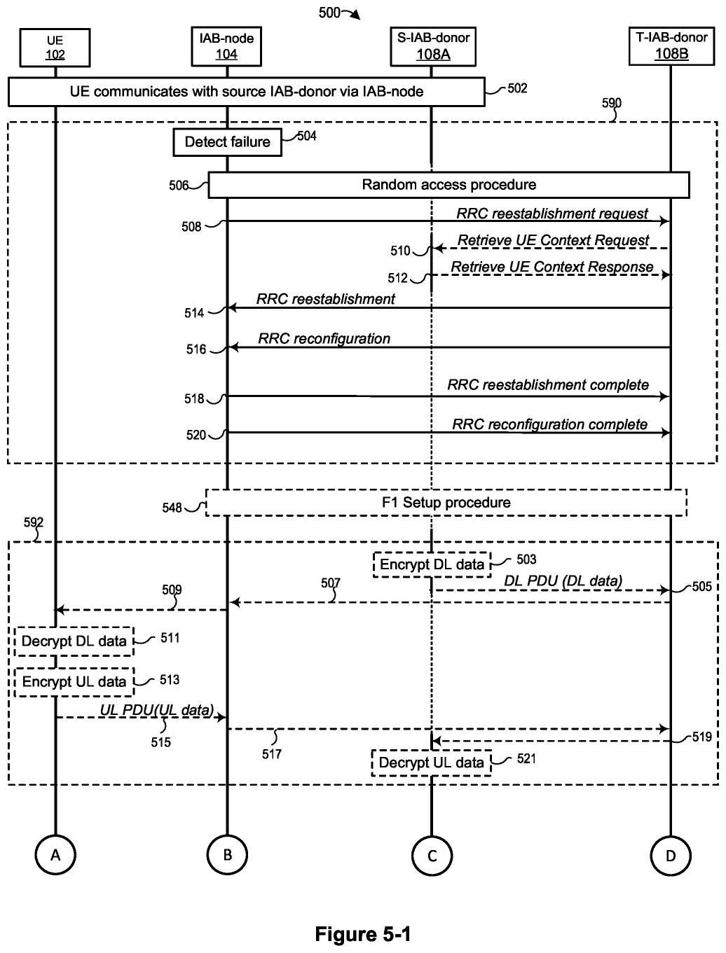

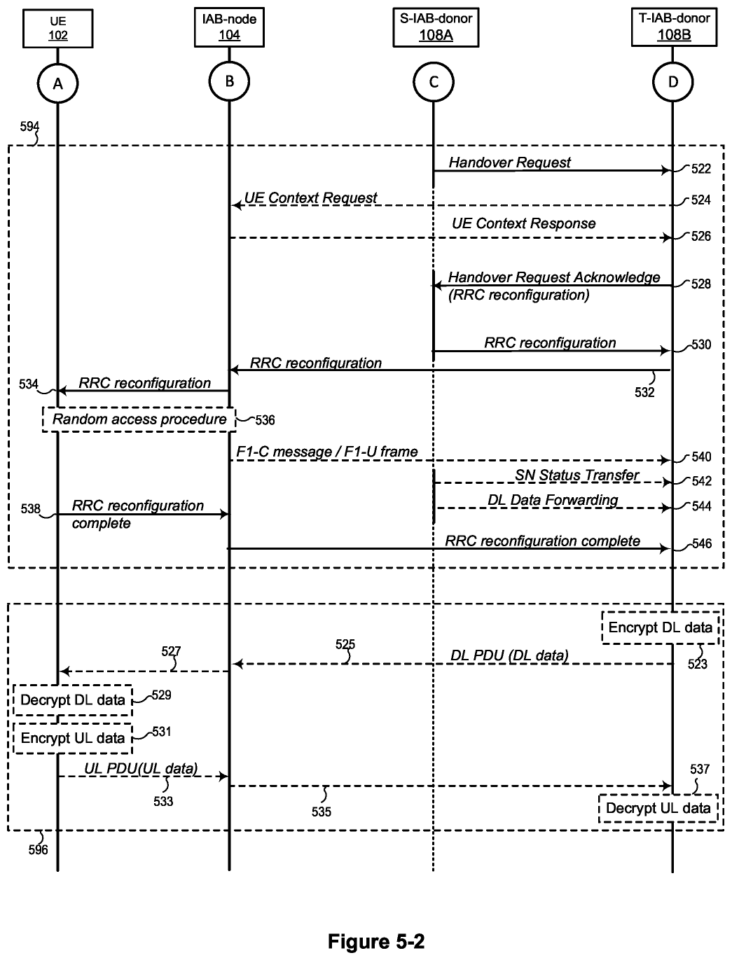

Next, FIGS. 5-10 illustrate several example scenarios, in which IAB-node 104 initiates an RRC connection reestablishment procedure and an IAB-donor (i.e., source IAB-donor 108A) initiates an inter-donor migration (e.g., handover) of UE 102 communicating with the source IAB-donor 108A via the IAB-node 104. Although a single IAB-node 104 connected directly to the UE 102 is shown in the following example scenarios, the IAB-node 104 can connect to the UE 102 via one or more intermediate IAB-nodes (e.g., IAB-node 106A, 106B).

In the following description, “IAB-node 104” and “UE 102” can represent one or multiple IAB-nodes and UEs 102A, 102B, respectively. In case of multiple UEs, the procedures performed by the UE 102 can mean each of the multiple UEs (e.g., UE 102A, UE 102B) performs the procedures, unless otherwise specified. The description for the UE 102 can apply to an IAB-MT of the IAB-node 104. Similarly, the procedures performed by the source IAB-donor 108A and the target IAB-donor 108B can apply to each of the multiple UEs (e.g., UE 102A, UE 102B).

Referring first to FIG. 5-1, in a scenario 500, the source IAB-donor 108A serves UE 102 via an IAB-node 104. Initially, the UE 102 communicates 502 data (e.g., uplink and/or downlink PDUs) with the source IAB-donor 108A via the IAB-node 104, e.g., in accordance with a source IAB-donor configuration. In some scenarios and implementations, the UE 102 communicates 502 data with the source IAB-donor 108A via the IAB-node 104 and intermediate IAB-node(s) (e.g., IAB-node 106A) between the IAB-node 104 and the source IAB-donor 108A. In other scenarios and implementations, the UE 102 communicates 502 data with the source IAB-donor 108A via the IAB-node 104 without any intermediate IAB-node(s) between the IAB-node 104 and the source IAB-donor 108A.

Later in time, the IAB-node 104 detects 504 failure. For example, the failure can be a radio link failure, a handover failure, integrity check failure, or reconfiguration failure. For example, the IAB-node 104 detects 504 a radio link failure on a connection with the source IAB-donor 108A. In another example, the IAB-node 104 receives an RRC message from the source IAB-donor 108A and detects 504 an integrity check failure on a MAC-I associated to the RRC message. In yet another example, the IAB-node 104 receives a handover command message from the source IAB-donor 108A instructing the IAB-node 104 to hand over to the target IAB-donor 108B, but detects 504 a handover failure because the IAB-node 104 fails the handover. In yet another example, the IAB-node 104 receives an RRC message (e.g., RRC reconfiguration message) from the source IAB-donor 108A and detects 504 a reconfiguration failure because the IAB-node 104 is unable to comply with a configuration in the RRC message.

In response to detecting 504 the failure, the IAB-node 104 initiates an RRC connection reestablishment procedure with the target IAB-donor 108B. In response to the initiation, the IAB-node 104 performs 506 a random access procedure with the target IAB-donor 108B and transmits 508 an RRC reestablishment request message to the target IAB-donor 108B. In some implementations, the random access procedure can be a two-step random access procedure or a four-step random access procedure.

In case of the four-step random access procedure, the IAB-node 104 can transmit a random access preamble to the target IAB-donor 108B, which in turn transmits a random access response to the IAB-node 104. After receiving the random access response, the IAB-node 104 transmits a message 3 (Msg3) including the RRC reestablishment request message to the target IAB-donor 108B on a physical uplink shared channel (PUSCH) in accordance with an uplink (UL) grant included in the random access response. In response to the RRC reestablishment request message, the target IAB-donor 108B transmits 514 an RRC reestablishment message to the IAB-node 104. In some implementations, the target IAB-donor 108B generates a first MAC PDU including a contention resolution identity and transmits the first MAC PDU to the IAB-node 104, so that the IAB-node 104 can determine that the four-step random access procedure succeeded in accordance with the contention resolution identity. In some implementations, the target IAB-donor 108B can include the RRC reestablishment message in the first MAC PDU and transmit 514 the first MAC PDU to the IAB-node 104. In other implementations, the target IAB-donor 108B generates a second MAC PDU including the RRC reestablishment message and transmits 514 the second MAC PDU to the IAB-node 104 after transmitting the first MAC PDU.

In case of the two-step random access procedure, the IAB-node 104 can transmit a message A (MSGA) with a random access preamble and the RRC reestablishment request message to the target IAB-donor 108B, which in turn transmits a message B (MSGB) indicating success of the two-step random access procedure to the IAB-node 104. In some implementations, the target IAB-donor 108B includes a successRAR MAC subPDU in the MSGB to indicate success of the two-step random access procedure. In some implementations, the target IAB-donor 108B can transmit 514 the MSGB including the RRC reestablishment message to the IAB-node 104. In other implementations, the target IAB-donor 108B generates a MAC PDU including the RRC reestablishment message and transmits 514 the MAC PDU to the IAB-node 104 after transmitting the MSGB.

In some implementations, the target IAB-donor 108B can request a context of the IAB-node 104 from the source IAB-donor 108B by transmitting 510 a Retrieve UE Context Request message to the source IAB-donor 108A after receiving 508 the RRC reestablishment request message. In receiving the Retrieve UE Context Request message, the source IAB-donor 108A can determine that the IAB-node 104 is to migrate from the source IAB-donor 108A to establish a new radio connection with the RAN 105. In response to receiving the Retrieve UE Context Request message, the source IAB-donor 108A sends 512 a Retrieve UE Context Response message including a context of the IAB-node 104 (e.g., RRC context) and/or security information to the target IAB-donor 108B. In some implementations, the source IAB-donor 108A can include, in the Retrieve UE Context Response message, a user plane setting such as Transport Network Layer information including Transport Layer Address and GTP-TEID for the IAB-node 104, so that the target IAB-donor 108B can later use the user plane setting to perform 592, 596 data communication procedures described further below with the UE 102 via the IAB-node 104. After receiving the Retrieve UE Context Response message, the target IAB-donor 108B transmits 514 the RRC reestablishment message to the IAB-node 104. After or in response to receiving the RRC reestablishment message, the IAB-node 104 transmits 518 an RRC reestablishment complete message to the target IAB-donor 108B.

In some implementations, the target IAB-donor 108B transmits 516 an RRC reconfiguration message to the IAB-node 104 after transmitting 514 the RRC reestablishment message or after receiving 518 the RRC reestablishment complete message. In some implementations, the target IAB-donor 108B can include the RRC reestablishment message and the RRC reconfiguration message in the MSGB or MAC PDU described above. In other implementations, the target IAB-donor 108B generates a separate MAC PDU including the RRC reconfiguration message and transmits 516 the separate MAC PDU to the IAB-node 104. In some implementations, the target IAB-donor 108B can generate the RRC reconfiguration message 516 for the IAB-node 104 in accordance with the context of the IAB-node 104. In other implementations, the target IAB-donor 108B can generate the RRC reconfiguration message 516 for the IAB-node 104 irrespective of the context of the IAB-node 104.

The IAB-node 104 transmits 520 an RRC reconfiguration complete message to the target IAB-donor 108B in response to the RRC reconfiguration message. In some implementations, the IAB-node 104 can generate a MAC PDU including the RRC reestablishment complete message and RRC reconfiguration complete message and transmits the MAC PDU to the target IAB-donor 108B. In other implementations, the IAB-node 104 can generate a first MAC PDU and a second MAC PDU including the RRC reestablishment complete message and RRC reconfiguration complete message, respectively. Then the IAB-node 104 transmits 518, 520 the first MAC PDU and the second MAC PDU to the target IAB-donor 108B.

In some implementations that are not shown, after receiving 518, 520 the RRC reestablishment complete message or the RRC reconfiguration complete message, the target IAB-donor 108B can send an interface message (e.g., an existing XnAP interface message or a new XnAP interface message) to the source IAB-donor 108A to indicate that the IAB-node 104 has successfully connected to the target IAB-donor 108B. In other implementations that are not shown, after receiving 518, 520 the RRC reestablishment complete message or the RRC reconfiguration complete message, the target IAB-donor 108B can send a UE Context Release message to the source IAB-donor 108A to indicate to the source IAB-donor 108A that radio and control plane resources for IAB-node 104 and/or a context of the IAB-node 104 are allowed to be released.

The events 504, 506, 508, 510, 512, 514, 516, 518 and 520 can be collectively referred as an IAB-node RRC reestablishment and reconfiguration procedure 590.

In some implementations, the security information included in the Retrieve UE Context Response message described above at event 512 can be AS security information, and includes a Key NG-RAN Start value and/or a Next Hop Chaining Count value. After receiving 512 the security information from the source IAB-donor 108A, the target IAB-donor 108B can include the Next Hop Chaining Count value in the RRC reestablishment message that is to be transmitted 514 to the IAB-node 104. The target IAB-donor 108B can use the security information to generate first security key(s), use the first security key(s) to perform security protection on the RRC reestablishment message at event 514 (i.e., protect integrity of the RRC reestablishment message), and transmit 514 the security-protected RRC reestablishment message to the IAB-node 104. In some implementations, the first security key(s) includes a first integrity key and/or a first encryption key. The target IAB-donor 108B performs integrity protection for the RRC reestablishment message using the first integrity key to generate an integrity-protected RRC reestablishment message (e.g., including the RRC reestablishment message, and a MAC-I generated from the RRC reestablishment message and the first integrity key), and sends 514 the integrity-protected RRC reestablishment message to the IAB-node 104.

After or in response to receiving 514 the integrity-protected RRC reestablishment message, the IAB-node 104 derives the first security key(s) (i.e., the same first security key(s) used by the target IAB-donor 108B) using configuration parameter(s) (e.g., the Next Hop Chaining Count value) in the RRC reestablishment message. In some implementations, the IAB-node 104 derives a base key using the configuration parameter(s) and derives the first security key(s) from the base key. For example, the IAB-node 104 derives the first integrity key from the base key and an integrity algorithm (parameter) and derives the first encryption key from the base key and a ciphering algorithm (parameter). The IAB-node 104 performs integrity check on the integrity-protected RRC reestablishment message (e.g., using the first integrity key to verify the MAC-I).

If the IAB-node 104 verifies that the integrity-protected RRC reestablishment message is valid (e.g., verify that the MAC-I is valid), the IAB-node 104 transmits 518 the RRC reestablishment complete message to the target IAB-donor 108B. In some implementations, the IAB-node 104 performs security protection on the RRC reestablishment complete message (e.g., protect integrity of the RRC reconfiguration message and/or encrypt the RRC reconfiguration message) by using the first security key(s), and transmits 518 the security-protected RRC reestablishment complete message to the target IAB-donor 108B. In some implementations, the IAB-node 104 performs integrity protection for the RRC reestablishment complete message using the first integrity key to generate an integrity-protected RRC reestablishment complete message (e.g., including the RRC reestablishment complete message, and a MAC-I generated from the RRC reestablishment complete message and the first integrity key), encrypts the integrity-protected RRC reestablishment complete message using the first encryption key, and sends 518 the encrypted and integrity-protected RRC reestablishment complete message to the target IAB-donor 108B.

Similarly, to transmit 516 the RRC reconfiguration message, the target IAB-donor 108B performs security protection on the RRC reconfiguration message (e.g., protect integrity of the RRC reconfiguration message and/or encrypt the RRC reconfiguration message) by using the first security key(s) and transmits 516 the security-protected RRC reconfiguration message to the IAB-node 104. In some implementations, the target IAB-donor 108B performs integrity protection for the RRC reconfiguration message using the first integrity key to generate an integrity-protected RRC reconfiguration message (e.g., including the RRC reconfiguration message, and a MAC-I generated from the RRC reconfiguration message and the first integrity key), encrypts the integrity-protected RRC reconfiguration message using the first encryption key, and sends 516 the encrypted and integrity-protected RRC reconfiguration message to the IAB-node 104.

After receiving 516 the (security-protected) RRC reconfiguration message, the IAB-node 104 decrypts and/or performs integrity check on the RRC reconfiguration message by using the first security key(s) (i.e., the same first security key(s) used by the target IAB-donor 108B), and applies configuration parameters in the RRC reconfiguration message to communicate with the target IAB-donor 108B. In some implementations, the IAB-node 104 receives 516 the encrypted and integrity-protected RRC reconfiguration message, decrypts the encrypted and integrity-protected RRC reconfiguration message using the first encryption key to generate a decrypted integrity-protected RRC reconfiguration message, and finally performs the integrity check on the decrypted integrity-protected RRC reconfiguration message using the first integrity key to obtain the original RRC reconfiguration message (e.g., using the first integrity key to verify or validate the MAC-I). If the IAB-node 104 verifies that the integrity-protected RRC reconfiguration message is valid (e.g., verify that the MAC-I is valid), the IAB-node 104 transmits 520 the RRC reconfiguration complete message to the target IAB-donor 108B as described above.

In some implementations, the IAB-node 104 performs security protection on the RRC reconfiguration complete message by using the first security key(s) and sends 520 the security-protected RRC reconfiguration complete message to the target IAB-donor 108B after the random access procedure 506 described above. In some implementations, the IAB-node 104 performs integrity protection for the RRC reconfiguration complete message using the first integrity key to generate an integrity-protected RRC reconfiguration complete message (e.g., including the RRC reconfiguration complete message, and a MAC-I generated from the RRC reconfiguration complete message and the first integrity key), encrypts the integrity-protected RRC reconfiguration complete message using the first encryption key, and sends 520 the encrypted and integrity-protected RRC reconfiguration complete message to the target IAB-donor 108B. After the receiving 520 the (security-protected) RRC reconfiguration complete message, the target IAB-donor 108B decrypts and/or performs integrity check on the RRC reconfiguration complete message by using the first security key(s) (i.e., the same first security key(s) used by the IAB-node 104). In some implementations, the target IAB-donor 108B receives 520 the encrypted and integrity-protected RRC reconfiguration complete message, decrypts the encrypted and integrity-protected RRC reconfiguration complete message using the first encryption key to generate a decrypted integrity-protected RRC reconfiguration complete message, and finally performs the integrity check on the decrypted integrity-protected RRC reconfiguration complete message using the first integrity key to obtain the original RRC reconfiguration complete message (e.g., using the first integrity key to verify or validate the MAC-I).

In some implementations, the context of the IAB-node 104 described above in event 512 includes first RRC configuration(s) used by the IAB-node 104 to communicate with the source IAB-donor 108A at event 502. In some implementations, the target IAB-donor 108B can generate second RRC configuration(s) in accordance with the first RRC configuration(s) or the RRC context and includes the second RRC configuration(s) in the RRC reconfiguration message to be transmitted 516 to the IAB-node 104. In other implementations, the target IAB-donor 108B can generate second RRC reconfiguration(s) by not referring to either of the first RRC configuration(s) or the RRC context, and includes the second RRC configuration(s) in the RRC reconfiguration message to be transmitted 516 to the IAB-node 104.

In some implementations, if the IAB-node 104 connects to the target IAB-donor 108B via a parent IAB-node (e.g., IAB-node 106A not shown in FIG. 5-1) of the IAB-node 104, the target IAB-donor 108B sends a UE Context Request message to the parent IAB-node. In response, the parent IAB-node generates the second RRC configuration(s) or at least a portion thereof for the IAB-node 104 and sends a UE Context Response message including the second RRC configuration(s) to the target IAB-donor 108B. Then, the target IAB-donor 108B includes the second RRC configuration(s) or at least a portion thereof in the RRC reconfiguration message to be transmitted 516 to the IAB-node 104. The IAB-node 104 communicates with the target IAB-donor 108B or the parent IAB-node in accordance with the second RRC configuration(s) or at least a portion thereof.

In some implementations, the UE Context Request message and UE Context Response message can be a UE Context Setup Request message and a UE Context Setup Response message, respectively. In other implementations, the UE Context Request message and UE Context Response message can be a UE Context Modification Request message and a UE Context Modification Response message, respectively. In some implementations, the UE Context Request message includes the BH RLC Channel to Be Setup (or Modified) List which may include the BH RLC CH ID, BH RLC CH QoS or E-UTRAN BH RLC CH QoS, Control Plane Traffic Type, RLC Mode, BAP Control PDU Channel, Traffic Mapping Information. The UE Context Request message may also include DRB to Be Setup (or Modified) List and BAP Address as defined in TS 38.473.

In some implementations, the RRC configuration(s) (i.e., the first RRC configuration(s), or second RRC configuration(s)) includes physical layer configuration parameters, MAC layer configuration parameters, and/or RLC configuration parameters. In other implementations, RRC configuration(s) can include a PDCP configuration, an SDAP configuration, and/or a radio bearer configuration (e.g., a RadioBearerConfig IE) that the IAB-node 104 uses to communicate with the source IAB-donor 108A. In some implementations, the RRC configuration(s) includes configuration parameters in an RRCReconfiguration message, RRCReconfiguration-IEs, or the CellGroupConfig IE conforming to 3GPP TS 38.331. In one implementation, the RRC configuration(s) can be an RRCReconfiguration message, RRCReconfiguration-IEs, or the CellGroupConfig IE conforming to 3GPP TS 38.331.

In some implementations, if the target IAB-donor 108B is a gNB, the RRC reestablishment request message, RRC reestablishment message, and RRC reestablishment complete are an RRCReestablishmentRequest message, an RRCReestablishment message, and an RRCReestablishmentComplete message, respectively. In other implementations, if the target IAB-donor 108B is a gNB, the RRC reconfiguration message and the RRC reconfiguration complete message are an RRCReconfiguration message and an RRCReconfigurationComplete message, respectively.

In some implementations, the target IAB-donor 108B may receive the context of the IAB-node 104, the security information, and/or the user plane setting from the source IAB-donor 108A in a Handover Request message instead of in the Retrieve UE Context Response message, before receiving 508 the RRC reestablishment request message. For example, the source IAB-donor 108A sends the Handover Request message for preparing a handover for the IAB-node 104 to the target IAB-donor 108B. In response, the target IAB-donor 108B sends a Handover Request Acknowledge message including a handover command message to the source IAB-donor 108A. The source IAB-donor 108A then sends the handover command message to the IAB-node 104, which in turn attempts to perform handover in accordance with the handover command message. However, the IAB-node 104 detects 504 a handover failure.

In another example, the source IAB-donor 108A sends the Handover Required message, including the context of the IAB-node 104, the security information, and/or the user plane setting, for preparing a handover for the IAB-node 104 to the CN 110. In turn, the CN 110 sends the Handover Request message to target IAB-donor 108B. In response, the target IAB-donor 108B sends a Handover Request Acknowledge message including a handover command message to the CN 110, which in turn sends a Handover Command message (i.e., an NGAP message) including the handover command message to the source IAB-donor 108A. The source IAB-donor 108A then sends the handover command message to the IAB-node 104, which in turn attempts to perform handover in accordance with the handover command message. However, the IAB-node 104 detects 504 a handover failure.

In some implementations, after receiving 518, 520 the RRC reestablishment complete message or the RRC reconfiguration complete message, the target IAB-donor 108B can send an indication message (e.g., XN-U ADDRESS INDICATION message) to the source IAB-donor 108A to provide a forwarding address (e.g., Xn-U Address Information in the XN-U ADDRESS INDICATION message), so that the source IAB-donor 108A can send 505 a downlink (DL) PDU including DL data to the target IAB-donor 108B in accordance with the forwarding address in a data communication procedure 592, as further described below.

After the IAB-node 104 connects to the target IAB-donor 108B, e.g., upon completion of the IAB-node RRC reestablishment and reconfiguration procedure 590, the IAB-node 104 can perform 548 an F1 Setup procedure with the target IAB-donor 108B. In some implementations, the IAB-node 104 establishes SCTP association(s) and/or an F1 interface (e.g., F1 connection or F1 interface instance) with the target IAB-donor 108B as a result of the F1 Setup procedure, so that the target IAB-donor 108B can perform F1AP procedure(s) (e.g., UE context procedure(s) such as at events 524, 526 discussed below) on the F1 interface with the IAB-node 104 for UE 102. In some implementations, the target IAB-donor 108B can perform the data communication procedure 592 and the F1 Setup procedure 548 in parallel or one after the other.

Although the IAB-node 104 connects to the target IAB-donor 108B, e.g., upon completion of the IAB-node RRC reestablishment and reconfiguration procedure 590, the target IAB-donor 108B does not have the context of the UE 102, the security information, and/or the user plane setting for the UE 102. Therefore, the target IAB-donor 108B cannot transmit DL data to UE 102 and fails to decrypt and/or check integrity of UL data received from the UE 102. To communicate UL data and DL data with the UE 102, the target IAB-donor 108B can perform 594 a UE handover procedure with the UE 102 and source IAB-donor 108A. Until the target IAB-donor 108B receives 538 a RRC configuration complete during the UE handover procedure 594 from the UE 102 to begin transmitting DL data to the UE 102 during data communication procedure 596, the UE 102 may experience data interruption caused by the failure detected by the IAB-node 104 at event 504. To minimize or avoid such data interruption, the source IAB-donor 108A can take advantage of the newly established connectivity between the IAB-node 104 and the target IAB-donor 108B to transmit DL data to the UE 102 during a data communication procedure 592, by transmitting the DL data to the target IAB-donor 108B, which in turn forwards the DL data to the UE 102 via the IAB-node 104. In some implementations, the target IAB-donor 108B can establish an UP association for a DRB of the UE 102 with the IAB-node 104 before, during, or after the F1 Setup procedure. For example, the target IAB-donor 108B transmits a DL USER DATA frame to the IAB-node 104 to establish the UP association, so that the target IAB-donor 108B can participate in the data communication procedure 592. After receiving the Retrieve UE Context Request message, the interface message (e.g., an existing XnAP message or a new XnAP message), the indication message (e.g., XN-U ADDRESS INDICATION message), or performing the F1 Setup procedure, the source IAB-donor 108A can transmit 505 DL data for the UE 102, received from the CN 110, to the target IAB-donor 108B, which in turn forwards 507 the DL data to the UE 102 via the IAB-node 104 and any existing downstream intermediate IAB-node(s).

In some implementations, the UE 102 communicates 502 data (e.g., UL and/or DL PDUs) with the source IAB-donor 108A via the IAB-node 104, by using second security key(s), and these same second security key(s) can be used by the source IAB-donor 108A to perform security protection on the DL data (e.g., protect integrity of the DL data and/or encrypt the DL data) at event 503. Then, the source IAB-donor 108A transmits 505 the security-protected DL data to the target IAB-donor 108B, which in turn transmits 507 the security-protected DL data to the IAB-node 104. Then, the IAB-node 104 transmits 509 the security-protected DL data to the UE 102 directly or via any intermediate IAB-node(s). After receiving the security-protected DL data, the UE 102 decrypts 511 and/or performs integrity check on the security-protected DL data by using the second security key(s) (i.e., the same second security key(s) used by the source IAB-donor 108A) to obtain the original DL data. In some implementations, the second security key(s) includes a second integrity key and a second encryption key. The source IAB-donor 108A performs integrity protection for a DL data packet, received from the CN 110, using the second integrity key to generate an integrity-protected DL data packet (e.g., including the DL data packet, and a MAC-I generated from the DL data packet and the second integrity key), encrypts 503 the integrity-protected DL data packet using the second encryption key, and sends a DL PDU including the encrypted and integrity-protected DL packet to the UE 102 via the target IAB-donor 108B, IAB-node 104, and any existing intermediate IAB-node(s). After receiving the DL PDU, the UE 102 extracts the encrypted and integrity-protected DL packet, decrypts 511 the encrypted and integrity-protected DL packet using the second encryption key to generate a decrypted integrity-protected DL packet, and finally performs the integrity check on the decrypted integrity-protected DL packet using the second integrity key to obtain the original DL data packet (e.g., using the second integrity key to verify or validate the MAC-I).

In other implementations, the second security key is a second encryption key. The UE 102 and the source IAB-donor 108A do not apply integrity protection in data communications at events 502 and 592. The source IAB-donor 108A encrypts 503 a DL data packet, received from the CN 110, using the second encryption key, and sends 505 a DL PDU including the encrypted DL packet to UE 102 via the target IAB-donor 108B and IAB-node 104. After receiving 509 the DL PDU including the encrypted DL packet, the UE 102 extracts the encrypted DL packet from the DL PDU, and decrypts 511 the encrypted data packet using the second encryption key to obtain the original DL data packet.

Before the UE 102 hands over to the target IAB-donor 108B during a UE handover procedure 594 further described below (e.g., before receiving 534 an RRC reconfiguration message), the UE 102 can transmit UL data to the source IAB-donor 108A. Particularly, the UE 102 can transmit 515 UL data to the IAB-node 104, which in turn forwards 517 the UL data to the target IAB-donor 108B. Then the target IAB-donor 108B can forward 519 the UL data to the source IAB-donor 108A. The UE 102 can perform security protection on the UL data (e.g., protect integrity of the UL data and/or encrypt the UL data) by using the second security key(s) and transmit 515, 517 the security-protected UL data to the target IAB-donor 108B via the IAB-node 104. Then the target IAB-donor 108B can forward 519 the security-protected UL data to the source IAB-donor 108A. After receiving the security-protected UL data, the source IAB-donor 108A decrypts 521 and/or performs integrity check on the security-protected UL data by using the second security key(s) (i.e., the same second security key(s) used by the UE 102) to obtain the original UL data.

In some implementations, the UE 102 performs integrity protection for an UL data packet using the second integrity key to generate an integrity-protected UL data packet (e.g., including the UL data packet, and a MAC-I generated from the UL data packet and the second integrity key), encrypts 513 the integrity-protected UL data packet using the second encryption key, and sends 515, 517 an UL PDU including the encrypted and integrity-protected UL packet to the target IAB-donor 108B via the IAB-node 104. Then, the target IAB-donor 108B can forward 519 the UL PDU to the source IAB-donor 108A. After receiving the UL PDU, the source IAB-donor 108A extracts the encrypted and integrity-protected UL packet, decrypts 521 the encrypted and integrity-protected UL packet using the second encryption key to generate a decrypted integrity-protected UL packet, and finally performs the integrity check on the decrypted integrity-protected UL packet using the second integrity key to obtain the original UL data packet (e.g., using the second integrity key to verify or validate the MAC-I).

In other implementations, the UE 102 and the source IAB-donor 108A do not apply integrity protection. The UE 102 encrypts 513 an UL data packet using the second encryption key, and sends 515 an UL PDU including the encrypted UL data packet to the IAB-node 104, which in turn transmits 517 the encrypted UL data packet to the target IAB-donor 108B. Then the target IAB-donor 108B forwards 519 the encrypted UL data packet to the source IAB-donor 108A. After receiving 519 the UL PDU including the encrypted UL data packet, the source IAB-donor 108A extracts the encrypted UL data packet from the UL PDU, and decrypts 521 the encrypted data packet using the second encryption key to obtain the original UL data packet.

After performing the IAB-node RRC reestablishment and reconfiguration procedure 590 (e.g., after receiving 510 the Retrieve UE Context Request message, or after receiving either the interface message or the indication message after events 518, 520), the source IAB-donor 108A can determine to hand over the UE 102 to the target IAB-donor 108B. In response to the determination, and with reference to FIG. 5-2, the source IAB-donor 108A begins to perform the UE handover procedure 594, by sending 522 a Handover Request message for the UE 102 to the target IAB-donor 108B.

In response to receiving 522 the Handover Request message, the target IAB-donor 108B sends 528 a Handover Request Acknowledge message including an RRC reconfiguration message (i.e., a second RRC reconfiguration message different from the RRC reconfiguration message of event 516) for the UE 102 to the source IAB-donor 108A. In some implementations, after receiving the Handover Request message, the target IAB-donor 108B can send 524 a UE Context Request message to the IAB-node 104. In response, the IAB-node 104 can send 526 a UE Context Response message. In some implementations, the IAB-node 104 may include a DU configuration (e.g., a CellGroupConfig IE) in the UE Context Response message, and the target IAB-donor 108B can include the DU configuration in the second RRC reconfiguration message at event 528. Some example implementations of the UE Context Request message and UE Context Response message are similar to the UE Context Request message and UE Context Response message described for event 590. In other implementations, the UE Context Request message may not include the BH RLC Channel to Be Setup (or Modified) List which may include the BH RLC CH ID, BH RLC CH QoS or E-UTRAN BH RLC CH QoS, Control Plane Traffic Type, RLC Mode, BAP Control PDU Channel, Traffic Mapping Information. The UE Context Request message may also include DRB to Be Setup (or Modified) List and BAP Address as defined in TS 38.473.

After the source IAB-donor 108A receives 528 the second RRC reconfiguration message, the source IAB-donor 108A transmits the second RRC reconfiguration message to the UE 102 via the target IAB-donor 108B and the IAB-node 104. That is, the source IAB-donor 108A transmits 530 the second RRC reconfiguration message to the target IAB-donor 108B, which in turn forwards 532 the second RRC reconfiguration message to the IAB-node 104. Then, the IAB-node 104 forwards 534 the second RRC reconfiguration message to the UE 102 directly or via any existing intermediate IAB-node(s).

In some implementations, to transmit 530 the second RRC reconfiguration message for the UE 102, the source IAB-donor 108A performs security protection on the second RRC reconfiguration message (e.g., protect integrity of the second RRC reconfiguration message and/or encrypt the second RRC reconfiguration message) by using third security key(s), and transmits 530 the security-protected second RRC reconfiguration message to the target IAB-donor 108B, which in turn forwards 532 the security-protected RRC second reconfiguration message to the IAB-node 104. Then, the IAB-node 104 transmits 534 the security-protected second RRC reconfiguration message to the UE 102. In some implementations, the third security key(s) includes a third integrity key and/or a third encryption key. The source IAB-donor 108A performs integrity protection on the second RRC reconfiguration message using the third integrity key to generate an integrity-protected second RRC reconfiguration message (e.g., including the second RRC reconfiguration message, and a MAC-I generated from the second RRC reconfiguration message and the third integrity key), encrypts the integrity-protected second RRC reconfiguration message using the third encryption key, and sends 530 the encrypted and integrity-protected second RRC reconfiguration message to the target IAB-donor 108B.

In some implementations, the target IAB-donor 108B can send 532 a UE Context Modification Request message or a DL RRC Message Transfer message including the (security-protected) second RRC reconfiguration message to the IAB-node 104. In turn, the IAB-node 104 can send a UE Context Modification Response message (not shown) to the target IAB-donor 108B in response to the UE Context Modification Request message.

After receiving 534 the (security-protected) second RRC reconfiguration message, the UE 102 decrypts and/or performs integrity check on the second RRC reconfiguration message by using the third security key(s) (i.e., the same third security key(s) used by the source IAB-donor 108A), and applies configuration parameters in the second RRC reconfiguration message to hand over to the target IAB-donor 108B. In some implementations, the UE 102 can receive 534 the encrypted and integrity-protected second RRC reconfiguration message, decrypt the encrypted and integrity-protected second RRC reconfiguration message using the third encryption key to generate a decrypted integrity-protected second RRC reconfiguration message, and finally perform the integrity check on the decrypted integrity-protected second RRC reconfiguration message using the third integrity key to obtain the original second RRC reconfiguration message (e.g., using the third integrity key to verify or validate the MAC-I).

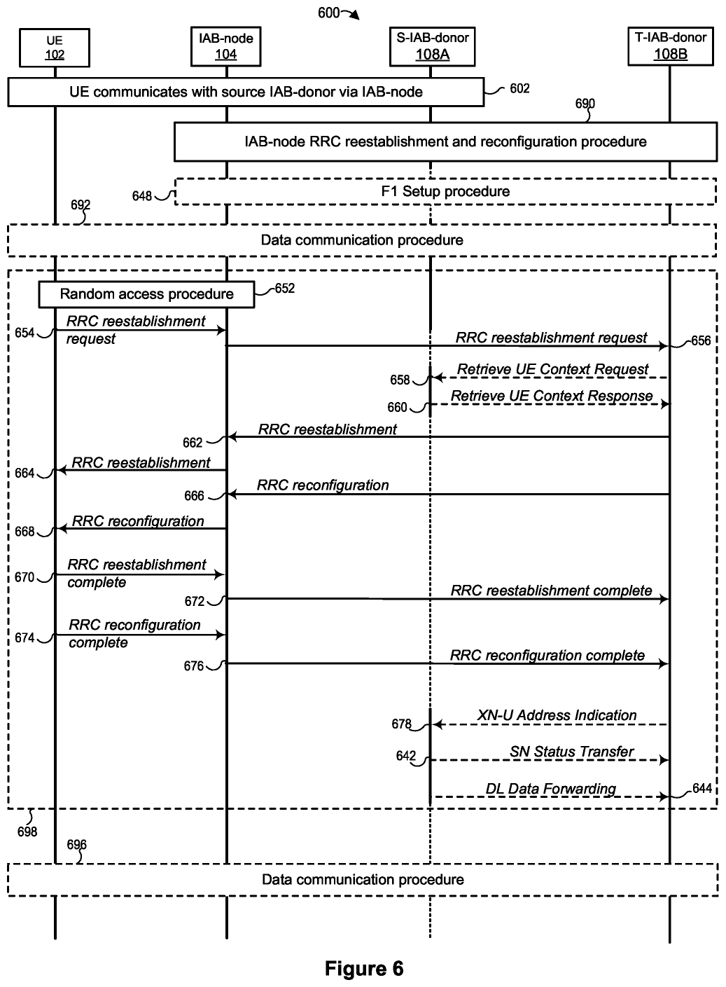

In some implementations, the UE 102 can perform 536 a random access procedure with the IAB-node 104, if instructed by the second RRC reconfiguration message. In some implementations, the random access procedure 536 is similar to the random access procedure 506. In response to receiving 534 the second RRC reconfiguration message, the UE 102 transmits 538 a second RRC reconfiguration complete message to the IAB-node 104, which in turn transmits 546 the second RRC reconfiguration complete message to the target IAB-donor 108B. In some implementations, if the UE 102 verifies or determines that the second RRC reconfiguration message is valid (i.e., verifying that the MAC-I is valid), the UE 102 transmits 538 the second RRC reconfiguration complete message to the IAB-node 104. If the UE 102 verifies or determines that the second RRC reconfiguration message is invalid (i.e., verifying that the MAC-I is invalid), the UE 102 performs a UE RRC reestablishment and reconfiguration procedure 698 with the target IAB-donor 108B described below with reference to FIG. 6.

In some implementations, the UE 102 performs security protection on the second RRC reconfiguration complete message by using fourth security key(s) and sends 538 the security-protected second RRC reconfiguration complete message to the IAB-node 104 during or after the random access procedure if performed at event 536. In some implementations, the UE 102 derives the fourth security key(s) from configuration parameter(s) (e.g., Next Hop Chaining Count value) included in the second RRC reconfiguration message.

In some implementations, the fourth security key(s) includes a fourth integrity key and/or a fourth encryption key. The UE 102 performs integrity protection on the second RRC reconfiguration complete message using the fourth integrity key to generate an integrity-protected second RRC reconfiguration complete message (e.g., including the second RRC reconfiguration complete message, and a MAC-I generated from the second RRC reconfiguration complete message and the second integrity key), encrypts the integrity-protected second RRC reconfiguration complete message using the fourth encryption key, and sends 538 the encrypted and integrity-protected second RRC reconfiguration complete message to the IAB-node 104. In turn, the IAB-node 104 transmits 546 the encrypted and integrity-protected second RRC reconfiguration complete message to the target IAB-donor 108B.

After receiving 546 the (security-protected) second RRC reconfiguration complete message, the target IAB-donor 108B decrypts and/or performs integrity check on the second RRC reconfiguration complete message by using the fourth security key(s) (i.e., the same fourth security key(s) used by the UE 102). In some implementations, the target IAB-donor 108B can receive 546 the encrypted and integrity-protected second RRC reconfiguration complete message, decrypt the encrypted and integrity-protected second RRC reconfiguration complete message using the fourth encryption key to generate a decrypted integrity-protected second RRC reconfiguration complete message, and finally perform the integrity check on the decrypted integrity-protected second RRC reconfiguration complete message using the fourth integrity key to obtain the original second RRC reconfiguration complete message (e.g., using the fourth integrity key to verify or validate the MAC-I). In some implementations, the target IAB-donor 108B derives the fourth security key(s) from configuration parameter(s) received in the Handover Request message at event 522. For example, the configuration parameter(s) includes a Key NG-RAN Start value and/or a Next Hop Chaining Count value. The Next Hop Chaining Count value can be the same as the Next Hop Chaining Count value in the second RRC reconfiguration message.

In some implementations, after transmitting 534 the second RRC reconfiguration message, performing the random access procedure 536 with UE 102, or receiving 538 the second RRC reconfiguration complete message 538, the IAB-node 104 can send 540 an F1-C message or an F1-U frame to the target IAB-donor 108B. In some implementation, the F1-C message or F1-U frame can be an Access Success message as defined in 3GPP specification 38.473 or a DL Data Delivery Status frame as defined in 3GPP specification 38.425.

In some implementations, after transmitting 522 the Handover Request message, receiving 528 the Handover Request Acknowledge message, or transmitting 530 the second RRC reconfiguration message, the source IAB-donor 108A can send 542 an SN Status Transfer message to the target IAB-donor 108B to transfer UL PDCP SN and HFN receiver status and DL PDCP SN and HFN transmitter status for DRB(s) of the UE 102 if the DRB(s) use an RLC Acknowledged Mode. Alternatively, or in addition to sending 542 the SN Status Transfer message, the source IAB-donor 108A can perform 544 DL data forwarding (i.e., send DL data that the source IAB-donor 108A received from CN 110, for the UE 102, to the target IAB-donor 108B). In some implementations, the DL data can be DL data packet(s) (e.g., Internet Protocol (IP) packet(s)) that the source IAB-donor 108A has not transmitted to the IAB-node 104. In other implementations, the DL data can be DL data packet(s) (e.g., IP packet(s)) that the source IAB-donor 108A has transmitted to the IAB-node 104 in the format of PDUs (e.g., PDCP PDUs), but has not yet been acknowledged by the UE 102 or the IAB-node 104.

Although not shown, in some implementations, after receiving 546 the second RRC reconfiguration complete message, the target IAB-donor 108B can send a Handover Success message to the source IAB-donor 108A to indicate successful handover of the UE 102 from the source IAB-donor 108A to the target IAB-donor 108B. In other implementations, after receiving the second RRC reconfiguration complete message, the SN Status Transfer message, or DL data at events 546, 542, or 544 respectively, the target IAB-donor 108B can send a UE Context Release message to the source IAB-donor 108A to indicate successful handover of the UE 102 from the source IAB-donor 108A to the target IAB-donor 108B, or to indicate to the source IAB-donor 108A that radio and control plane resources for the UE 102 and/or a context of the UE 102 are allowed to be released.

In some implementations, after receiving 546 the second RRC reconfiguration complete message, the target IAB-donor 108B can send a Path Switch Request message (not shown) for the UE 102 to CN 110 (e.g., AMF 164) to trigger the CN 110 to switch a DL data path towards the target IAB-donor 108B and/or to establish an NG-C interface instance towards the target IAB-donor 108B. In response, the CN 110 switches a DL data path towards the target IAB-donor 108B for the UE 102 and/or establishes an NG-C interface instance towards the target IAB-donor 108B for the UE 102, and sends a Patch Switch Response message to the target IAB-donor 108B. After switching the DL data path towards the target IAB-donor 108B, the CN 110 sends DL data for the UE 102 to the target IAB-donor 108B. In turn, the target IAB-donor 108B can perform 596 a data communication procedure to transmit the DL data (e.g., DL data received from the source IAB-donor 108A and/or the CN 110) to the UE 102.

The events 522, 524, 526, 528, 530, 532, 534, 536, 538, 540, 542, 544 and 546 can be collectively referred as the UE handover procedure 594.

After the target IAB-donor 108B receives the F1-C message/F1-U frame or the second RRC reconfiguration complete message at events 540 or 546, respectively, the target IAB-donor 108B perform 596 a data communication procedure, in which the target IAB-donor 108B transmits 525 the DL data that the target IAB-donor 108B received from the source IAB-donor 108A and/or the CN 110 as described above. The target IAB-donor 108B can perform security protection on the DL data (e.g., protect integrity of the DL data and/or encrypt 523 the DL data) by using fifth security key(s) (e.g., fifth encryption key and/or fifth integrity key) and transmits 525 the security-protected DL data to the IAB-node 104, which in turn transmits 527 the security-protected DL data to the UE 102 directly or via one or more intermediate IAB-nodes. In some implementations, the target IAB-donor 108B derives the fifth security key(s) from configuration parameter(s) (e.g., Key NG-RAN Start value and/or a Next Hop Chaining Count value) received in the Handover Request message at event 522.

After receiving the security-protected DL data, the UE 102 decrypts 529 and/or performs integrity check on the security-protected DL data by using the fifth security key(s) (i.e., the same fifth security key(s) used by the target IAB-donor 108B) to obtain the original DL data, in a similar manner as described above, e.g., using the fifth encryption key to decrypt the security-protected DL data and/or using the fifth integrity key to verify or validate the MAC-I. In some implementations, the UE 102 derives the fifth security key(s) from configuration parameter(s) included in the second RRC reconfiguration message. For example, the configuration parameter(s) includes the Next Hop Chaining Count value which can be the same as the Next Hop Chaining Count value in the Handover Request message at event 522.

After performing 536 the random access procedure or transmitting 538 the second RRC reconfiguration complete message, the UE 102 can transmit 533 UL data to the IAB-node 104, which in turn transmit 535 the UL data to the target IAB-donor 108B. The UE 102 can perform 531 security protection on the UL data (e.g., protect integrity of the UL data and/or encrypt the UL data) by using the fifth security key(s) and transmits 533 the security-protected UL data to the IAB-node 104, which in turn transmits 535 the security-protected UL data to the target IAB-donor 108B. After receiving 535 the security-protected UL data, the target IAB-donor 108B decrypts 537 and/or performs integrity check on the security-protected UL data by using the fifth security key(s) (i.e., the same fifth security key(s) used by the UE 102) to obtain the original UL data, in a similar manner as described above, e.g., using the fifth encryption key to decrypt the security-protected UL data and/or using the fifth integrity key to verify or validate the MAC-I.

In some implementations, the source TAB-donor 108A includes TAB information in the Retrieve UE Context Response message at event 512. Thus, the target TAB-donor 108B can transmit 507, 525 or route DL PDUs for the UE 102 to the IAB-node 104 in accordance with the TAB information. For example, the TAB information includes a topology and backhaul related information, IP address information of the IAB-node 104 and intermediate IAB-node(s) (if existing), and/or identity(ies) of the IAB-node 104 and intermediate IAB-node(s) (if existing). The topology and backhaul related information may include information such as the BAP mapping configuration, which contains the backhaul routing information (e.g., the BAP Routing ID, BAP Address(es) and/or traffic mapping information).

In other implementations, the source TAB-donor 108A can include, in the Retrieve UE Context Response message at event 512, the NG-C UE associated Signaling Reference, Signaling TNL association address at source NG-C side, UE Security Capabilities, Index to RAT/Frequency Selection Priority, Location Reporting Information, UE Aggregate Maximum Bit Rate, PDU Session Resources To Be Setup List, and/or UE Context Reference at the IAB-node (e.g., Global NG-RAN Node ID, GNB-DU UE F1AP ID).

In other implementations, the TAB information is not carried in a Retrieve UE Context Response message but in another new interface message (e.g., new X2AP or XnAP message, or an IAB Information Transfer message). The source TAB-donor 108A can send the new interface message to the target TAB-donor 108B after receiving the Retrieve UE Context Request message or transmitting the Retrieve UE Context Response message.

By the techniques described in the above example scenario of FIG. 5 (i.e., FIGS. 5-1 and 5-2), after the IAB-node 104 performs the IAB-node RRC reestablishment and reconfiguration procedure 590 with the source TAB-donor 108A and the target TAB-donor 108B, data communication can continue to flow among the UE 102, the source TAB-donor 108A, and the target TAB-donor 108B during data communication procedure 592 until the UE 102 is configured to communicate with the target TAB-donor 108B via the IAB-node 104 during the UE handover procedure 594. Thus, long data interruption caused by the failure detected at event 504 by the IAB-node 104 can be minimized or avoided.

Now referring to FIG. 6, whereas the source TAB-donor 108A of FIG. 5 performs a UE handover procedure 594 to equip the UE 102 with an RRC configuration of the target TAB-donor 108B to communicate with the target TAB-donor 108B, the UE 102 of FIG. 6 receives an RRC configuration of the target IAB-donor 108B during a UE RRC reestablishment and reconfiguration procedure 698 instead of the UE handover procedure 594. Otherwise, any of the implementations described above in reference to FIG. 5 can be applied to scenario 600 of FIG. 6.

Similar to scenario 500, in scenario 600 of FIG. 6, the UE 102 initially communicates 602 data (e.g., uplink and/or downlink PDUs) with the source IAB-donor 108A via the IAB-node 104, similar to event 502. Then, the source IAB-donor 108A performs an IAB-node RRC reestablishment and reconfiguration procedure 690 with the target IAB-donor 108B, similar to the IAB-node RRC reestablishment and reconfiguration procedure 590. In some implementations, after the IAB-node 104 connects to the target IAB-donor 108B, e.g., upon completion of the IAB-node RRC reestablishment and reconfiguration procedure 690, the IAB-node 104 can perform 648 an F1 Setup procedure with the target IAB-donor 108B, similar to event 548, and the target IAB-donor 108B can perform a data communication procedure 692 with the UE 102, similar to the data communication procedure 592.

After the IAB-node 104 connects to the target IAB-donor 108B during or upon completion of the IAB-node RRC reestablishment and reconfiguration procedure 690, the UE 102 and the target IAB-donor 108B can perform a UE RRC reestablishment and reconfiguration procedure 698 via the IAB-node 104 instead of performing the UE handover procedure 594 described in scenario 500. After performing the UE RRC reestablishment and reconfiguration procedure 698, the UE 102 can perform a data communication procedure 696, similar to the data communication procedure 596, with the target IAB-donor 108B via the IAB-node 104.

In some implementations, during or after the IAB-node RRC reestablishment and reconfiguration procedure 690, the target IAB-donor 108B, another IAB-node (e.g., IAB-node 106B), the IAB-node 104, or a downstream intermediate IAB-node of the IAB-node 104 can transmit a PDU or RRC message to the UE 102, which causes the UE 102 to begin the UE RRC reestablishment and reconfiguration procedure 698 (e.g., perform 652 a random access procedure with the IAB-node 104 to transmit 654 the RRC reestablishment request message to the IAB-node 104). For example, the PDU includes an invalid RRC message, or the RRC message is an invalid RRC message, so that the UE 102 detects integrity check failure or reconfiguration failure on the RRC message. In response to detecting the integrity check failure or reconfiguration failure, the UE 102 begins the UE RRC reestablishment and reconfiguration procedure 698 (e.g., transmits 654 the RRC reestablishment request message to the IAB-node 104). In another example, the RRC message can instruct the UE 102 to begin the UE RRC reestablishment and reconfiguration procedure 698 (e.g., instruct the UE 102 to transmit 654 the RRC reestablishment request message to the IAB-node 104).

In other implementations, during or after the IAB-node RRC reestablishment and reconfiguration procedure 690, the IAB-node 104 can broadcast an RRC message (e.g., a system information block) to the UE 102 (e.g., UE 102A and UE 102B) which causes each UE 102 connected to the IAB-node 104 to perform the UE RRC reestablishment and reconfiguration procedure 698 with the target IAB-donor 108B via the IAB-node 104. For example, the RRC message can instruct each UE 102 to begin the UE RRC reestablishment and reconfiguration procedure 698 (e.g., instruct the UE 102 to transmit 654 the RRC reestablishment request message to the IAB-node 104).

In yet other implementations, during or after the IAB-node RRC reestablishment and reconfiguration procedure 690, the IAB-node 104 can cause the UE 102 to detect a radio link failure. For example, the IAB-node 104 can temporarily stop transmission or lower transmission power of signals to cause the UE 102 to detect radio link failure. In another example, the IAB-node 104 can switch off a cell or lower transmission power on the cell where the UE 102 is communicating with the IAB-node 104 to cause the UE 102 to detect radio link failure. In response to detecting the radio link failure, the UE 102 begins the UE RRC reestablishment and reconfiguration procedure 698 with the target IAB-donor 108B via the IAB-node 104 (e.g., transmits 654 an RRC reestablishment request message to the IAB-node 104).

To begin the UE RRC reestablishment and reconfiguration procedure 698, the UE 102 can perform 652 a random access procedure with the IAB-node 104. During or after the random access procedure, the UE 102 transmits 654 an RRC reestablishment request message to the IAB-node 104, which in turn transmits 656 the RRC reestablishment request message to the target IAB-donor 108B. In response, the target IAB-donor 108B transmits 662 an RRC reestablishment message to the IAB-node 104, which in turn transmits 694 the RRC reestablishment message to the UE 102. In some implementations, the random access procedure 652 can be a two-step random access procedure or a four-step random access procedure.

In case of the four-step random access procedure, the UE 102 can transmit a random access preamble to the IAB-node 104, which in turn transmits a random access response to the UE 102. After receiving the random access response, the UE 102 transmits 654 Msg3 including the RRC reestablishment request message to the IAB-node 104 on a PUSCH in accordance with an UL grant included in the random access response. In turn, the IAB-node 104 transmits 656 the RRC reestablishment request message to the target IAB-donor 108B. In response to receiving 656 the RRC reestablishment request message, the target IAB-donor 108B transmits 662 the RRC reestablishment message to the IAB-node 104. In some implementations, the IAB-node 104 generates a first MAC PDU including a contention resolution identity and transmits the first MAC PDU to the IAB-node 104, so that the UE 102 can determine that the four-step random access procedure succeeded in accordance with the contention resolution identity. In some implementations, the IAB-node 104 can include the RRC reestablishment message received at event 662 in the first MAC PDU and transmit 664 the first MAC PDU to the UE 102. In other implementations, the IAB-node 104 generates a second MAC PDU including the RRC reestablishment message received at event 662 and transmits 664 the second MAC PDU to the UE 102 after transmitting the first MAC PDU.

In case of the two-step random access procedure, the UE 102 can transmit 654 MSGA consisting of a random access preamble and the RRC reestablishment request message to the IAB-node 104. In turn, the IAB-node 104 transmits 656 the RRC reestablishment request message to the target IAB-donor 108B. In response to the MSGA, the IAB-node 104 transmits MSGB indicating success of the two-step random access procedure to the UE 102. In some implementations, the IAB-node 104 includes a successRAR MAC subPDU in the MSGB to indicate success of the two-step random access procedure. In some implementations, the IAB-node 104 can transmit 664 the MSGB including the RRC reestablishment message to the UE 102. In other implementations, the IAB-node 104 generates a MAC PDU including the RRC reestablishment message received at event 662 and transmits 664 the MAC PDU to the IAB-node 104 after transmitting the MSGB.

In some implementations, the target IAB-donor 108B can transmit 658 a Retrieve UE Context Request message to the source IAB-donor 108A after receiving 656 the RRC reestablishment request message. In response, the source IAB-donor 108A sends 660 a Retrieve UE Context Response message including a context of the UE 102 (e.g., RRC context) and/or security information to the target IAB-donor 108B. In some implementations, the context of the UE 102 includes a first RRC configuration that the UE 102 uses to communicate with the IAB-node 104 at event 602. After receiving the Retrieve UE Context Response message, the target IAB-donor 108B can transmit 662 the RRC reestablishment message to the IAB-node 104.

After receiving 664 the RRC reestablishment message, the UE 102 transmits 670 an RRC reestablishment complete message to the IAB-node 104, which in turn transmits 672 the RRC reestablishment complete message to the target IAB-donor 108B.

In some implementations, the target IAB-donor 108B generates an RRC reconfiguration message and transmits 666 the RRC reconfiguration message to the IAB-node 104 after transmitting 662 the RRC reestablishment message or receiving 672 the RRC reestablishment complete message. In some implementations, the target IAB-donor 108B can generate the RRC reconfiguration message for the UE 102 either in accordance with the context of the UE 102, or irrespective of the context of the UE 102. In some implementations, the target IAB-donor 108B can generate a second RRC configuration either in accordance with the first RRC configuration or the context of the UE 102, or irrespective of the first RRC configuration or the context of the UE 102, and include the second RRC configuration or at least a portion thereof in the RRC reconfiguration message. In yet other implementations, the target IAB-donor 108B can send a UE Context Request message to the IAB-node 104, which in turn generates the second RRC configuration for the UE 102 and sends a UE Context Response message including the second RRC configuration to the target IAB-donor 108B. Then, the target IAB-donor 108B includes the second RRC configuration or at least a portion thereof in the RRC reconfiguration message.

After receiving 666 the RRC reconfiguration message, the IAB-node 104 can transmit 668 the RRC reconfiguration message to the UE 102. In some implementations, the IAB-node 104 can include the RRC reestablishment message and the RRC reconfiguration message in the MSGB or MAC PDU described above. In other implementations, the IAB-node 104 generates a separate MAC PDU including the RRC reconfiguration message and transmits 668 the separate MAC PDU to the UE 102.

In response to receiving 668 the RRC reconfiguration message, the UE 102 transmits 674 an RRC reconfiguration complete message to the IAB-node 104, which in turn transmits 676 the RRC reconfiguration complete message to the target IAB-donor 108B. In some implementations, the UE 102 can generate a MAC PDU including the RRC reestablishment complete message and RRC reconfiguration complete message and transmits the MAC PDU to the IAB-node 104. In other implementations, the UE 102 can generate a first MAC PDU and a second MAC PDU including the RRC reestablishment complete message and RRC reconfiguration complete message, respectively, and subsequently transmit 670, 674 the respective first MAC PDU and the second MAC PDU to the IAB-node 104.

In some implementations, after receiving the RRC reestablishment complete message or the RRC reconfiguration complete message at events 672 or 676 respectively, the target IAB-donor 108B can send 678 an indication message (e.g., XN-U ADDRESS INDICATION message) to the source IAB-donor 108A to provide a forwarding address (e.g., Xn-U Address Information in the XN-U ADDRESS INDICATION message), so that the source IAB-donor 108A can forward 644 DL data to the target IAB-donor 108B in accordance with the forwarding address. In some implementations, after receiving the RRC reestablishment complete message or the RRC reconfiguration complete message at events 672 or 676 respectively, the target IAB-donor 108B can send a Path Switch Request message (not shown) for the UE 102 to CN 110 (e.g., AMF 164) to trigger the CN 110 to switch a DL data path towards the target IAB-donor 108B and/or to establish an NG-C interface instance towards the target IAB-donor 108B. In response, the CN 110 switches a DL data path towards the target IAB-donor 108B for the UE 102 and/or establishes an NG-C interface instance towards the target IAB-donor 108B for the UE 102, and sends a Patch Switch Response message to the target IAB-donor 108B. After switching the DL data path towards the target IAB-donor 108B, the CN 110 sends DL data for the UE 102 to the target IAB-donor 108B. In turn, the target IAB-donor 108B can perform 696 a data communication procedure to transmit the DL data (e.g., DL data received from the source IAB-donor 108A and/or the CN 110) to the UE 102.

In some implementations, after receiving the Retrieve UE Context Request message or the indication message at events 658 or 678 respectively, or transmitting 660 the Retrieve UE Context Response message, the source IAB-donor 108A can send 642 an SN Status Transfer message to the target IAB-donor 108B to transfer UL PDCP SN and HFN receiver status and DL PDCP SN and HFN transmitter status for DRB(s) of the UE 102 if the DRB(s) use an RLC Acknowledged Mode. Alternatively, or in addition to sending 642 the SN Status Transfer message, the source IAB-donor 108A can perform 644 DL data forwarding (i.e., send DL data that the source IAB-donor 108A received from CN 110, for the UE 102, to the target IAB-donor 108B). In some implementations, the DL data can be DL data packet(s) (e.g., Internet Protocol (IP) packet(s)) that the source IAB-donor 108A has not transmitted to the IAB-node 104. In other implementations, the DL data can be DL data packet(s) (e.g., IP packet(s)) that the source IAB-donor 108A has transmitted to the IAB-node 104 in the format of PDUs (e.g., PDCP PDUs), but has not yet been acknowledged by the UE 102 or the IAB-node 104.

In some implementations, after receiving the RRC reconfiguration complete message, the SN Status Transfer message, or DL data at events 676, 642, or 644 respectively, the target IAB-donor 108B can send a UE Context Release message to the source IAB-donor 108A to indicate to the source IAB-donor 108A that radio and control plane resources for the UE 102 and/or a context of the UE 102 are allowed to be released.

The events 652, 654, 656, 658, 660, 662, 664, 666, 668, 670, 672, 674, 676, 678, 642, and 644 can be collectively referred as a UE RRC reestablishment and reconfiguration procedure 698.

In some implementations, similar to the manner described above in scenario 500, the target IAB-donor 108B can use security information included in the Retrieve UE Context Response message at event 660 to generate security key(s), and use the security key(s) to perform security protection on the RRC reestablishment message and the RRC reconfiguration message at events 662 and 666, respectively, that are sent to the UE 102 via the IAB-node 104. After receiving the security-protected RRC reestablishment message, the UE 102 can derive the same security key(s) used by the target IAB-donor 108B using configuration parameter(s) included in the RRC reestablishment message. It is with these derived security key(s) that the UE 102 can perform 696 the data communication procedure described above with the target IAB-donor 108B via the IAB-node 104, similar to data communication procedure 596. Similarly, after receiving the security-protected RRC reconfiguration message, the UE 102 can decrypt and/or perform integrity check on the RRC reconfiguration message using the derived security key(s).

If the UE 102 verifies that the security-protected RRC reestablishment message and the security-protected RRC reconfiguration message are valid, the UE 102 transmits the RRC reestablishment complete message and the RRC reconfiguration complete message to the IAB-node 104 at events 670 and 674 respectively, which in turn transmits the RRC reestablishment complete message and the RRC reconfiguration complete message to the target IAB-donor 108B respectively. In some implementations, the UE 102 performs security protection on the RRC reestablishment complete message and the RRC reconfiguration complete message by using the same derived security key(s) similar to the manner described above in scenario 500. After receiving 676 the security-protected RRC reconfiguration complete message, the target IAB-donor 108B decrypts and/or performs integrity check on the RRC reconfiguration complete message by using the security key(s) to obtain the original RRC reconfiguration complete message.

If the UE 102 verifies that the integrity-protected RRC reestablishment message is not valid (e.g., verify that the MAC-I included in the RRC reestablishment message is invalid), the UE 102 discards the RRC reestablishment message and disconnects from the IAB-node 104. In some implementations, after disconnecting from the IAB-node 104, the UE 102 can perform an RRC connection establishment procedure with the target IAB-donor 108B via the IAB-node 104 to establish a connection with the target IAB-donor 108B. To perform the RRC connection establishment procedure, the UE 102 transmits an RRC setup request message to the target IAB-donor 108B via the IAB-node 104 without performing security protection on the RRC setup request message. In response, the target IAB-donor 108B transmits an RRC setup message to the UE 102 via the IAB-node 104 without performing security protection on the RRC setup message. In response, the UE 102 transmits an RRC setup complete message to the target IAB-donor 108B via the IAB-node 104 without performing security protection on the RRC setup complete message. After completing the RRC connection establishment procedure with the UE 102, the target IAB-donor 108B can transmit a security mode command message to the UE 102 via the IAB-node 104 to activate security protection. In response, the UE 102 activates security protection and derives security key(s) in accordance with configuration parameter(s) included in the security mode command message, and transmits a security mode complete message to the target IAB-donor 108B via the IAB-node 104. After activating the security protection, the target IAB-donor 108B can perform an RRC reconfiguration procedure with the UE 102 via the IAB-node 104, similar to events 666, 668, 674, and 676.

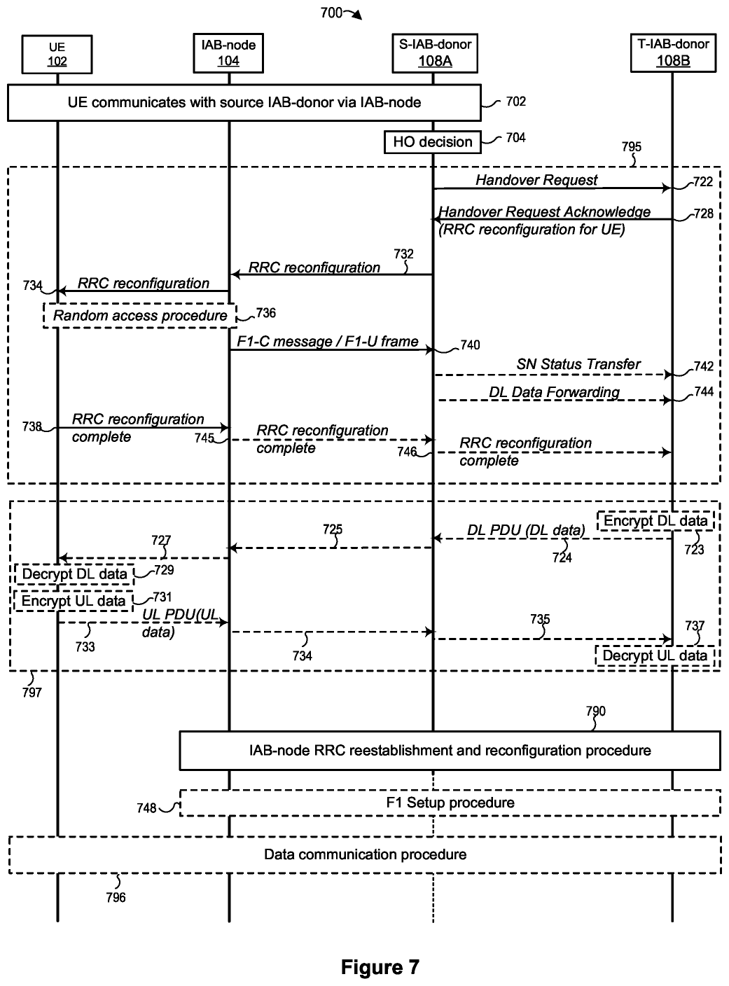

Now referring to FIG. 7, whereas the source IAB-donor 108A of FIG. 5 performs a UE handover procedure 594 after the IAB-node 104 detects failure during the IAB-node RRC reestablishment and reconfiguration procedure 590, the source IAB-donor 108A of FIG. 7 performs a UE handover procedure 795 before the IAB-node 104 detects failure during the IAB-node RRC reestablishment and reconfiguration procedure 790. Otherwise, any of the implementations described above in reference to FIG. 5 can be applied to scenario 700 of FIG. 7.

Similar to scenario 500, in scenario 700 of FIG. 7, the UE 102 initially communicates 702 data (e.g., uplink and/or downlink PDUs) with the source IAB-donor 108A via the IAB-node 104, similar to event 502. Then, before the source IAB-donor 108A performs an IAB-node RRC reestablishment and reconfiguration procedure 790 with the target IAB-donor 108B, similar to the IAB-node RRC reestablishment and reconfiguration procedure 590, the source IAB-donor 108A at some point determines 704 to hand over the UE 102 to the target IAB-donor 108B. The source IAB-donor 108A can make this determination based on one or more measurement results received from the IAB-node 104 and/or the UE 102, for example, or another suitable event (e.g., topology change commanded by a network node such as an operation and maintenance (O&M) node). In response to determining to handover the UE 102, the source IAB-donor 108A initiates a UE handover procedure 795 by sending 722 a Handover Request message to the target IAB-donor 108B, similar to event 522, which in turn sends 728 a Handover Request Acknowledge message including an RRC reconfiguration message to the source IAB-donor 108A, similar to event 528. In some implementations, in response to determining to handover the UE 102, the source IAB-donor 108A can also determine that the IAB-node 104 is to migrate from the source IAB-donor 108A to establish a new radio connection with the RAN 105. In such implementations, the source IAB-donor 108A can transmit, to the target IAB-donor 108B, the context of the IAB-node in the Handover Request message.

The UE handover procedure 795 of FIG. 7 is different than the UE handover procedure 594 of FIG. 5. Because the source IAB-donor 108A of FIG. 5 initiates the UE handover procedure 594 after the IAB-node 104 connects to the target IAB-donor 108B as a result of detecting 504 failure during the IAB-node RRC reestablishment and reconfiguration procedure 590, the source IAB-donor 108A no longer has a direct connection to the IAB-node 104. Thus, the source IAB-donor 108A sends an RRC reconfiguration message to the UE 102 via the target IAB-donor 108B and the IAB-node 104 at events 530, 532, and 534. In contrast, because the source IAB-donor 108A of FIG. 7 initiates the UE handover procedure 795 before the IAB-node 104 connects to the target IAB-donor 108B as a result of detecting failure during the IAB-node RRC reestablishment and reconfiguration procedure 790, the source IAB-donor 108A still has a connection to the IAB-node 104. Thus, the source IAB-donor 108A need not send the RRC reconfiguration message received at event 708 to the UE 102 via the target IAB-donor 108B and the IAB-node 104 like at events 530, 532, and 534. Rather, the source IAB-donor 108A can send the RRC reconfiguration message to the UE 102 via the IAB-node 104 (i.e., and not via the target IAB-donor 108B) at events 732, 734.

After receiving the RRC reconfiguration message, the UE 102 performs 736 a random access procedure with the IAB-node 104, similar to event 536, and transmits 738 an RRC reconfiguration complete message to the IAB-node 104, similar to event 538. In contrast to event 546, the IAB-node 104 in turn transmits 745 the RRC reconfiguration complete message to the source IAB-donor 108A because the source IAB-donor 108A still has a connection to the IAB-node 104, and the source IAB-donor 108A in turn transmits 746 the RRC reconfiguration complete message to the target IAB-donor 108B. Thus, the target IAB-donor 108B, in receiving the RRC reconfiguration complete message at event 746, is aware that the UE 102 successfully handed over to the target IAB-donor 108B.

In some implementations, similar to event 540, the IAB-node 104 can send 740 an F1-C message or an F1-U frame to the source IAB-donor 108A instead of the target IAB-donor 108B. In some implementations, similar to events 542 and 544, the source IAB-donor 108A can send 742 an SN Status Transfer message to the target IAB-donor 108B and/or perform 744 DL data forwarding with the target IAB-donor 108B.

The events 722, 728, 732, 734, 736, 738, 740, 742, 744, 745, and 746 can be collectively referred as the UE handover procedure 795.

After the source IAB-donor 108A successfully hands over the UE 102 to the target IAB-donor 108B (e.g., after the target IAB-donor 108B receives the RRC reconfiguration complete message at event 746), the target IAB-donor 108B performs a data communication procedure 797 similar to the data communication procedure 796, except that the source IAB-donor 108A participates in the communication procedure 797 unlike the data communication procedure 796 because the source IAB-donor 108A still has a connection to the IAB-node 104. The target IAB-donor 108B can process the DL data received at event 744 by encrypting 723 the DL data during the data communication procedure 797, similar to event 523. Subsequently, the target IAB-donor 108B sends the encrypted DL data to the IAB-node 104 via the source IAB-donor 108A at events 724, 725. In turn, the IAB-node 104 transmits 727 the encrypted DL data to the UE 102, similar to event 527. The UE 102 can then decrypt 729 the DL data, similar to event 529. The UE 102 can also send UL data to the target IAB-donor 108B during the data communication procedure 797. The UE 102 can encrypt 731 UL data, similar to event 531, and send 733 the encrypted UL data to the IAB-node 104, similar to event 533. In turn, the IAB-node 104 can send the encrypted UL data to the target IAB-donor 108B via the source IAB-donor 108A at events 734, 735. The target IAB-donor 108B can then decrypt 737 the UL data, similar to event 537. The events 723, 724, 725, 727, 729, 731, 733, 734, 735, and 737 can be collectively referred as the data communication procedure 797.

As described above, in some implementations, during or after the UE handover procedure 795, the IAB-node 104 performs an IAB-node RRC reestablishment and reconfiguration procedure 790, similar to the IAB-node RRC reestablishment and reconfiguration procedure 590. Subsequent to performing the IAB-node RRC reestablishment and reconfiguration procedure 790, the IAB-node 104 can perform 748 an F1 Setup procedure with the target IAB-donor 108B, similar to event 548. Because by this point, the UE 102 has already handed over to the target IAB-donor 108B according to the UE handover procedure 795, the target IAB-donor 108B can readily perform 796 a data communication procedure to transmit the DL data to the UE 102 via the IAB-node 104 (i.e., and without including the source IAB-donor 108A), similar to data communication procedure 596. Events 744 and 797 that occurred before the IAB-node 104 detected failure at event 790 can minimize or avoid data interruption experienced by the UE 102 caused by the failure.

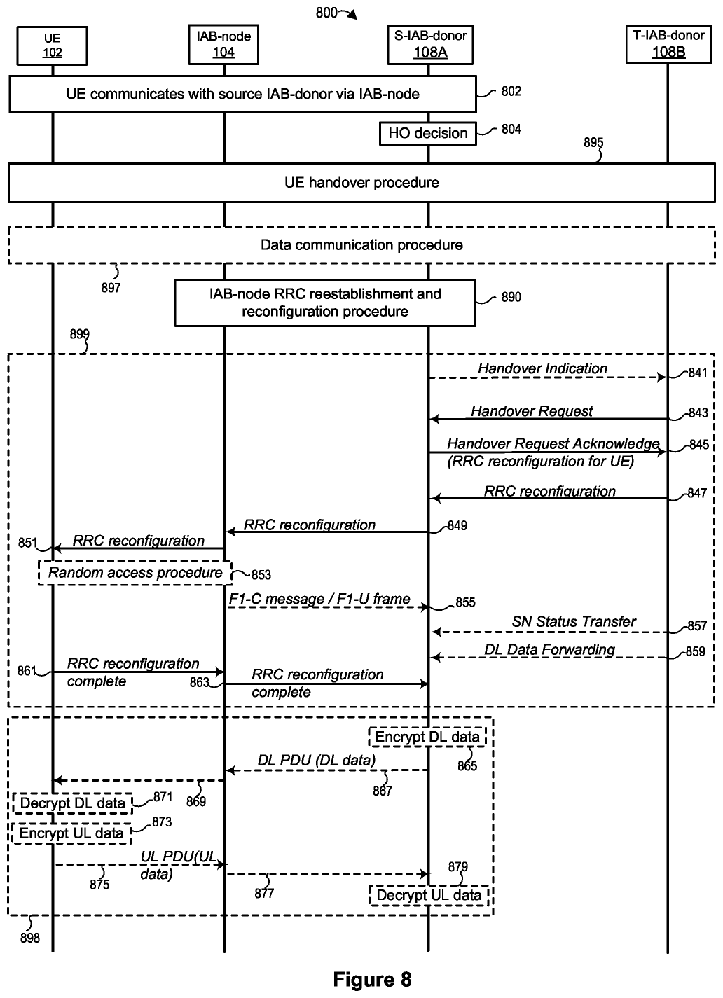

Now referring to FIG. 8, whereas the source IAB-donor 108A of FIG. 7 performs a UE handover procedure 795 with the target IAB-donor 108B, resulting in the UE 102 and the target IAB-donor 108B performing a data communication procedure 796, the source IAB-donor 108A or target IAB-donor 108B of FIG. 8 determines to hand over the UE 102 back to the source IAB-donor 108A, resulting in the UE 102 and the source IAB-donor 108A performing a data communication procedure 898. Otherwise, any of the implementations described above in reference to FIG. 7 can be applied to scenario 800 of FIG. 8.

Similar to scenario 700, in scenario 800 of FIG. 8, the UE 102 initially communicates 802 data (e.g., uplink and/or downlink PDUs) with the source IAB-donor 108A via the IAB-node 104, similar to event 702. Then, the source IAB-donor 108A at some point determines 804 to hand over the UE 102 to the target IAB-donor 108B, similar to event 704. In response to this determination, the source IAB-donor 108A performs a UE handover procedure 895, similar to event 795. After the source IAB-donor 108A performs the UE handover procedure 895 with the UE 102 and the target IAB-donor 108B, the target IAB-donor 108B optionally performs a data communication procedure 897, similar to event 797.

In some implementations, whereas the IAB-node 104 of FIG. 7 connects to the target IAB-donor 108B upon completion of the IAB-node RRC reestablishment and reconfiguration procedure 790, the IAB-node 104 of FIG. 8 re-connects to the source IAB-donor 108A after detecting failure at event 890. For example, the IAB-node 104 may detect failure due to a sudden signal drop with the source IAB-donor 108A, but quickly finds a strong signal with the source IAB-donor 108A. In another example, the IAB-node 104 may detect failure as described for event 590.

Subsequently, the source IAB-donor 108A determines that the target IAB-donor 108B should hand over the UE 102 back to the source IAB-donor 108A. In response, the source IAB-donor 108A can send 841 a Handover Indication message to the target IAB-donor 108B to initiate the UE handover procedure 899. In other implementations, the target IAB-donor 108B instead of the source IAB-donor 108A determines to hand over the UE 102 back to the source IAB-donor 108A, e.g., after receiving a measurement report from the UE 102 via the IAB-node 104 and the source IAB-donor 108A indicating that the UE 102 is better suited to hand over back to the source IAB-donor 108A or due to load-balancing or service robustness.

As such, in response to the Handover Indication message, the measurement report, or determination made due to load-balancing or service robustness, the target IAB-donor 108B can transmit 843 a Handover Request message to the source IAB-donor 108A, which in turn sends 845 a Handover Request Acknowledge message including an RRC reconfiguration message to the target IAB-donor 108B.

The target IAB-donor 108B sends the RRC reconfiguration message to the IAB-node 104 via the source IAB-donor 108A (acting as the new target IAB-donor) at events 847 and 849. In turn, the IAB-node 104 sends 851 the RRC reconfiguration message to the UE 102. In some implementations, as described in FIG. 5, the target IAB-donor 108B can encrypt the RRC reconfiguration message with security key(s) at event 847, and the UE 102 can decrypt the RRC reconfiguration message with the same security key(s) at event 851.

After receiving the RRC reconfiguration message, the UE 102 performs 853 a random access procedure with the IAB-node 104, similar to event 736, and transmits 861 an RRC reconfiguration complete message to the IAB-node 104, similar to event 738. The IAB-node 104 in turn transmits 863 the RRC reconfiguration complete message to the source IAB-donor 108A, similar to event 745.

In some implementations, the IAB-node 104 can send 855 an F1-C message or an F1-U frame to the source IAB-donor 108A, similar to event 740. In some implementations, the target IAB-donor 108B can send 857 an SN Status Transfer message to the source IAB-donor 108A and/or perform 859 DL data forwarding with the source IAB-donor 108A.

The events 841, 843, 845, 847, 849, 851, 853, 855, 857, 859, 861, and 863 can be collectively referred as the UE handover procedure 899. This UE handover procedure 899 hands the UE back to S-IAB-donor 108A via IAB-node 104.

After the target IAB-donor 108B completes the UE handover procedure 899 with the UE 102 and the source IAB-donor 108A (e.g., after the source IAB-donor 108A receives the RRC reconfiguration complete message at event 863), the source IAB-donor 108A performs a data communication procedure 898 similar to the data communication procedure 592, except that the source IAB-donor 108A need not send DL data to the IAB-node 104 via the target IAB-donor 108B because the target IAB-donor 108B has already handed over the UE 102 to the source IAB-donor 108A upon completion of the UE handover procedure 899. The source IAB-donor 108A can encrypt 865 the DL data and send 867 the encrypted DL data to the IAB-node 104. In turn, the IAB-node 104 transmits 869 the encrypted DL data to the UE 102. The UE 102 can then decrypt 871 the DL data. The UE 102 can also send UL data to the source IAB-donor 108A during the data communication procedure 898. The UE 102 can encrypt 873 UL data and send 875 the encrypted UL data to the IAB-node 104. In turn, the IAB-node 104 can send 877 the encrypted UL data to the source IAB-donor 108A. The source IAB-donor 108A can then decrypt 879 the UL data. The events 865, 867, 869, 871, 873, 875, 877, and 879 can be collectively referred as the data communication procedure 898.

In some implementations, instead of the UE handover procedure 899, the UE 102 can establish a connection with the source IAB-donor 108A according to a UE RRC reestablishment and reconfiguration procedure, similar to the manner in which the UE 102 establishes a connection with the target IAB-donor 108B according to the UE RRC reestablishment and reconfiguration procedure 698.

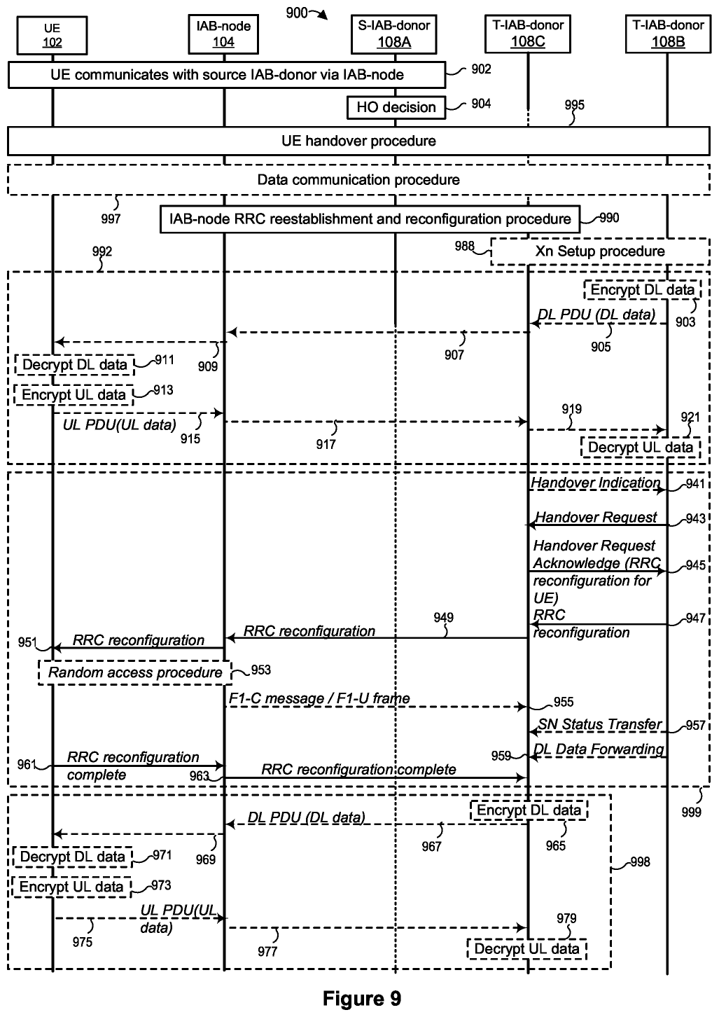

Now referring to FIG. 9, whereas the UE 102 of FIG. 8 is handed over from the target IAB-donor 108B back to the source IAB-donor 108A, resulting in the UE 102 and the source IAB-donor 108A performing a data communication procedure 898, the UE 102 of FIG. 9 is handed over to another target IAB-donor (e.g., target IAB-donor 108C), resulting in the UE 102 and the target IAB-donor 108C performing a data communication procedure 998. Otherwise, any of the implementations described above in reference to FIG. 8 can be applied to scenario 900 of FIG. 9.

Similar to scenario 800, in scenario 900 of FIG. 9, the UE 102 initially communicates 902 data (e.g., uplink and/or downlink PDUs) with the source IAB-donor 108A via the IAB-node 104, similar to event 802. Then, the source IAB-donor 108A at some point determines 904 to hand over the UE 102 to the target IAB-donor 108B, similar to event 804. In response to this determination, the source IAB-donor 108A performs a UE handover procedure 995, similar to event 895. After the source IAB-donor 108A performs the UE handover procedure 995 with the UE 102 and the target IAB-donor 108B, the target IAB-donor 108B performs a data communication procedure 997, similar to event 897.

In some implementations, whereas the IAB-node 104 of FIG. 7 connects to the target IAB-donor 108B upon completion of the IAB-node RRC reestablishment and reconfiguration procedure 790, the IAB-node 104 of FIG. 9 connects to a different target IAB-donor (e.g., target IAB-donor 108C) after detecting failure at event 990.

Although the IAB-node 104 connects to the target IAB-donor 108C, e.g., upon completion of the IAB-node RRC reestablishment and reconfiguration procedure 990, the target IAB-donor 108C does not have the context of the UE 102, the security information, and/or the user plane setting for the UE 102. Therefore, the target IAB-donor 108C cannot transmit DL data to UE 102 and fails to decrypt and/or check integrity of UL data received from the UE 102. Meanwhile, the target IAB-donor 108B cannot transmit DL data to the UE 102 and receive UL data from the UE 102 via the IAB-node 104 because the IAB-node 104 has connected to the target IAB-donor 108C as a result of the IAB-node RRC reestablishment and reconfiguration procedure 990. Therefore, data interruption between the UE 102 and target IAB-donor 108B occurs. To minimize or avoid such data interruption, the target IAB-donor 108C can take advantage of a connection with the target IAB-donor 108C established by performing 988 an Xn Setup procedure and/or UE-associated signaling procedure with the target IAB-donor 108B, so that the target IAB-donor 108B can transmit DL data to the UE 102 via the target IAB-donor 108C during a data communication procedure 992, similar to the data communication procedure 592. In some implementations, the target IAB-donor 108C can send an interface message to the target IAB-donor 108B to perform the UE-associated signaling procedure. For example, the interface message can be a new XnAP message or an existing XnAP message with a new information element, which indicates to the target IAB-donor 108B that the IAB-node 104 has connected to the target IAB-donor 108C. In another example, the interface message can be a Handover Indication message at event 941 discussed below.

In some implementations of the data communication procedure 992, the target IAB-donor 108B can encrypt 903 the DL data using security key(s) and send 905 the encrypted DL data to the target IAB-donor 108C. The target IAB-donor 108C can forward 907 the encrypted DL data to the IAB-node 104, which in turn forwards 909 the encrypted DL data to the UE 102. The UE 102 can decrypt 911 the DL data using the same security key(s) used by the target IAB-donor 108B to encrypt the DL data. The UE 102 can also send UL data to the target IAB-donor 108B during the data communication procedure 992. The UE 102 can encrypt 913 UL data and send 915 the encrypted UL data to the IAB-node 104. In turn, the IAB-node 104 can forward 917 the encrypted UL data to the target IAB-donor 108C, which in turn forwards 919 the encrypted UL data to the target IAB-donor 108B. The target IAB-donor 108B can then decrypt 921 the UL data.

After performing the IAB-node RRC reestablishment and reconfiguration procedure 990, the target IAB-donor 108C determines that the target IAB-donor 108B should hand over the UE 102 to the target IAB-donor 108C, e.g., in response to the Xn Setup procedure 988 and/or the UE-associated signaling procedure or after receiving measurement reports from the IAB-node 104 indicating that the UE 102 is better suited to hand over to the target IAB-donor 108C. In response, the target IAB-donor 108C can send 941 a Handover Indication message to the target IAB-donor 108B to initiate the UE handover procedure 999, similar to the UE handover procedure 899. In other implementations, the target IAB-donor 108B instead of the target IAB-donor 108C determines to hand over the UE 102 to the target IAB-donor 108C, e.g., in response to the Xn Setup procedure 988 and/or the UE-associated signaling procedure or after receiving a measurement report from the UE 102 via the IAB-node 104 and the target IAB-donor 108C using the connection established in response to the Xn Setup procedure 988 and/or the UE-associated signaling procedure, indicating that the UE 102 is better suited to hand over to the target IAB-donor 108C.

As such, either in response to the Handover Indication message or the measurement report, the target IAB-donor 108B can transmit 943 a Handover Request message to the target IAB-donor 108C, which in turn sends 945 a Handover Request Acknowledge message including an RRC reconfiguration message to the target IAB-donor 108B. In response, the target IAB-donor 108B sends the RRC reconfiguration message to the IAB-node 104 via the target IAB-donor 108C at events 947 and 949. In turn, the IAB-node 104 sends 951 the RRC reconfiguration message to the UE 102. In some implementations, as described in FIG. 5, the target IAB-donor 108B can encrypt the RRC reconfiguration message with security key(s) at event 947, and the UE 102 can decrypt the RRC reconfiguration message with the same security key(s) at event 951.

After receiving the RRC reconfiguration message, the UE 102 performs 953 a random access procedure with the IAB-node 104, and transmits 961 an RRC reconfiguration complete message to the IAB-node 104. The IAB-node 104 in turn transmits 963 the RRC reconfiguration complete message to the target IAB-donor 108C. In some implementations, the IAB-node 104 can send 955 an F1-C message or an F1-U frame to the target IAB-donor 108C. In some implementations, the target IAB-donor 108B can send 957 an SN Status Transfer message to the target IAB-donor 108C and/or perform 959 DL data forwarding with the target IAB-donor 108C. The events 941, 943, 945, 947, 949, 951, 953, 955, 957, 959, 961, and 963 can be collectively referred as the UE handover procedure 999.

After the target IAB-donor 108B completes the UE handover procedure 999 with the UE 102 and the target IAB-donor 108C (e.g., after the target IAB-donor 108C receives the RRC reconfiguration complete message at event 963), the target IAB-donor 108C performs a data communication procedure 998 similar to the manner in which the source IAB-donor 108A performs the data communication procedure 898. The target IAB-donor 108C can encrypt 965 the DL data and send 967 the encrypted DL data to the IAB-node 104. In turn, the IAB-node 104 transmits 969 the encrypted DL data to the UE 102. The UE 102 can then decrypt 971 the DL data. The UE 102 can also send UL data to the target IAB-donor 108C during the data communication procedure 998. The UE 102 can encrypt 973 UL data and send 975 the encrypted UL data to the IAB-node 104. In turn, the IAB-node 104 can send 977 the encrypted UL data to the target IAB-donor 108C. The target IAB-donor 108C can then decrypt 979 the UL data. The events 965, 967, 969, 971, 973, 975, 977, and 979 can be collectively referred as the data communication procedure 998.

In some implementations, instead of the UE handover procedure 999, the UE 102 can establish a connection with the target IAB-donor 108C according to a UE RRC reestablishment and reconfiguration procedure, similar to the manner in which the UE 102 establishes a connection with the target IAB-donor 108B according to the UE RRC reestablishment and reconfiguration procedure 698.

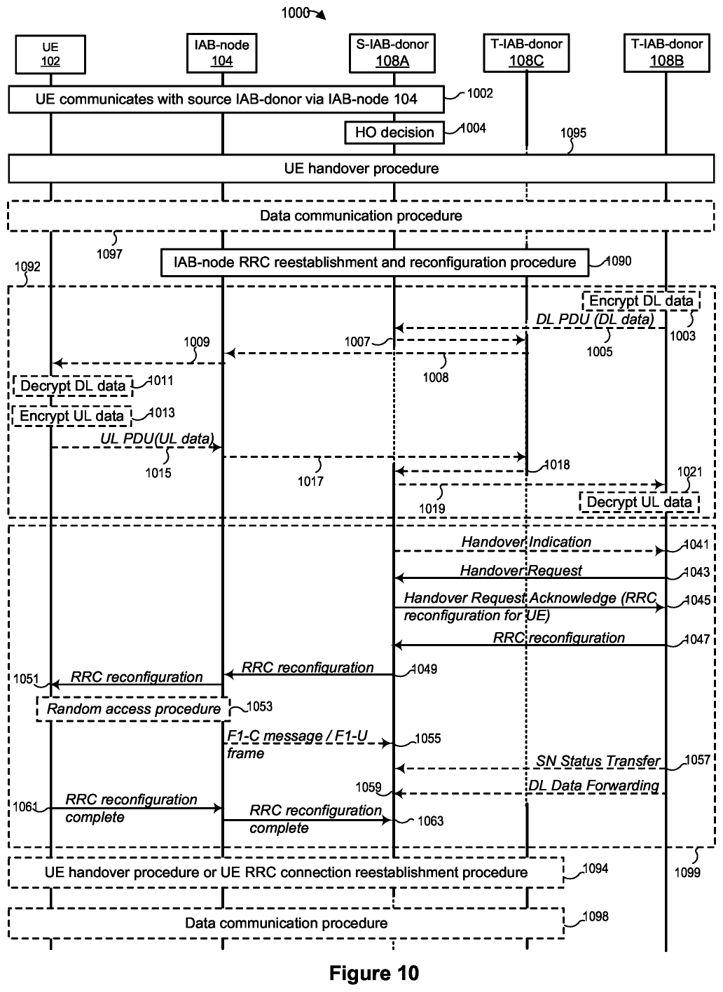

Now referring to FIG. 10, whereas the target IAB-donor 108B of FIG. 9 is aware of the target IAB-donor 108C (e.g., as a result of the Xn Setup procedure 988), the target IAB-donor 108B of FIG. 10 is unaware of the target IAB-donor 108C. Accordingly, the source IAB-donor 108A of FIG. 10, which is aware of the target IAB-donor 108C, can facilitate procedures with the target IAB-donor 108B so that the UE 102 and the target IAB-donor 108C can perform a data communication procedure 1098, similar to the data communication procedure 998.

Similar to scenario 900, in scenario 1000 of FIG. 10, the UE 102 initially communicates 1002 data (e.g., uplink and/or downlink PDUs) with the source IAB-donor 108A via the IAB-node 104, similar to event 902. Then, the source IAB-donor 108A at some point determines 1004 to hand over the UE 102 to the target IAB-donor 108B, similar to event 904. In response to this determination, the source IAB-donor 108A performs a UE handover procedure 1095, similar to event 995. After the source IAB-donor 108A performs the UE handover procedure 1095 with the UE 102 and the target IAB-donor 108B, the target IAB-donor 108B performs a data communication procedure 1097, similar to event 997. Subsequently, the IAB-node 104 performs an IAB-node RRC reestablishment and reconfiguration procedure 1090 with the target IAB-donor 108C, similar to the IAB-node RRC reestablishment and reconfiguration procedure 990.

Although the IAB-node 104 connects to the target IAB-donor 108C, the target IAB-donor 108C does not have the context of the UE 102, the security information, and/or the user plane setting for the UE 102. Therefore, the target IAB-donor 108C cannot transmit DL data to UE 102 and fails to decrypt and/or check integrity of UL data received from the UE 102. Meanwhile, the target IAB-donor 108B cannot transmit DL data to the UE 102 and receive UL data from the UE 102 via the IAB-node 104 because the IAB-node 104 has connected to the target IAB-donor 108C as a result of the IAB-node RRC reestablishment and reconfiguration procedure 1090. Therefore, data interruption between the UE 102 and target IAB-donor 108B occurs. To minimize or avoid such data interruption, the target IAB-donor 108B can transmit DL data to the UE 102 during a data communication procedure 1092. However, because the target IAB-donor 108B is not aware of the target IAB-donor 108C, the target IAB-donor 108B is unable to transmit DL data to the UE 102 via the target IAB-donor 108C like in data communication procedure 992. Instead, the target IAB-donor 108B can transmit DL data to the UE 102 via the source IAB-donor 108A.

In some implementations of the data communication procedure 1092, the target IAB-donor 108B can encrypt 1003 the DL data using security key(s) and send 1005 the encrypted DL data to the source IAB-donor 108A. The source IAB-donor 108A, which is aware of the target IAB-donor 108C (e.g., from event 1090), can forward 1007 the encrypted DL data to the target IAB-donor 108C, which in turn forwards 1008 the encrypted DL data to the IAB-node 104. The IAB-node 104 then forwards 1009 the encrypted DL data to the UE 102. The UE 102 can decrypt 1011 the DL data using the same security key(s) used by the target IAB-donor 108B to encrypt the DL data. The UE 102 can also send UL data to the target IAB-donor 108B during the data communication procedure 1092. The UE 102 can encrypt 1013 UL data and send 1015 the encrypted UL data to the IAB-node 104. In turn, the IAB-node 104 can forward 1017 the encrypted UL data to the target IAB-donor 108C, which in turn forwards 1018 the encrypted UL data to the source IAB-donor 108A. The source IAB-donor 108A then forwards 1019 the encrypted UL data to the target IAB-donor 108B, which can then decrypt 1021 the UL data.

After performing the IAB-node RRC reestablishment and reconfiguration procedure 1090, the source IAB-donor 108A determines that the target IAB-donor 108B should hand over the UE 102 to the target IAB-donor 108C, e.g., in response to the Retrieve UE Context Request message in the IAB-node RRC reestablishment and reconfiguration procedure, or after receiving measurement reports from the IAB-node 104 indicating that the UE 102 is better suited to hand over to the target IAB-donor 108C. Because the target IAB-donor 108B is unaware of the target IAB-donor 108C, the source IAB-donor 108A can send 1041 a Handover Indication message to the target IAB-donor 108B to initiate the UE handover procedure 1099 to hand over the UE 102 back to the source IAB-donor 108A first, so that the source IAB-donor 108A can later hand over the UE 102 to the target IAB-donor 108C at event 1094. In other implementations, the target IAB-donor 108B instead of the source IAB-donor 108A determines to hand over the UE 102 back to the source IAB-donor 108A, e.g., for load balancing, service robustness or reducing latency.

As such, either in response to the Handover Indication message or the determination, the target IAB-donor 108B can transmit 1043 a Handover Request message to the source IAB-donor 108A, which in turn sends 1045 a Handover Request Acknowledge message including an RRC reconfiguration message to the target IAB-donor 108B. In response, the target IAB-donor 108B sends the RRC reconfiguration message to the IAB-node 104 via the source IAB-donor 108A at events 1047 and 1049. In turn, the IAB-node 104 sends 1051 the RRC reconfiguration message to the UE 102. In some implementations, as described in FIG. 5, the target IAB-donor 108B can encrypt the RRC reconfiguration message with security key(s) at event 1047, and the UE 102 can decrypt the RRC reconfiguration message with the same security key(s) at event 1051.

After receiving the RRC reconfiguration message, the UE 102 performs 1053 a random access procedure with the IAB-node 104, and transmits 1061 an RRC reconfiguration complete message to the IAB-node 104. The IAB-node 104 in turn transmits 1063 the RRC reconfiguration complete message to the source IAB-donor 108A. In some implementations, the IAB-node 104 can send 1055 an F1-C message or an F1-U frame to the source IAB-donor 108A. In some implementations, the target IAB-donor 108B can send 1057 an SN Status Transfer message to the source IAB-donor 108A and/or perform 1059 DL data forwarding with the source IAB-donor 108A. The events 1041, 1043, 1045, 1047, 1049, 1051, 1053, 1055, 1057, 1059, 1061, and 1063 can be collectively referred as the UE handover procedure 1099.

After the target IAB-donor 108B completes the UE handover procedure 1099 with the UE 102 and the source IAB-donor 108A (e.g., after the source IAB-donor 108A receives the RRC reconfiguration complete message at event 1063), the source IAB-donor 108A proceeds to hand over the UE 102 to the target IAB-donor 108C according to the UE handover procedure at event 1094, similar to the manner in which the UE 102 is handed over to the target IAB-donor 108B during the UE handover procedure 594, in some implementations. In other implementations, instead of the UE handover procedure 1094, the UE 102 can establish a connection with the target IAB-donor 108C according to a UE RRC reestablishment and reconfiguration procedure at event 1094, similar to the manner in which the UE 102 establishes a connection with the target IAB-donor 108B according to the UE RRC reestablishment and reconfiguration procedure 698.

After either the UE handover procedure or the UE RRC reestablishment and reconfiguration procedure at event 1094, the target IAB-donor 108C performs a data communication procedure 1098 similar to the data communication procedure 998.

Several example methods that the UE 102 and the IAB-node(s), source IAB-donor node, and target IAB-donor node(s) of this disclosure can implement are considered next. Each of these methods can be implemented using suitable processing hardware such as for example one or more processors configured to execute instructions stored on a non-transitory computer-readable medium.

Referring now to FIG. 11, an example method 1100 can be implemented in a source IAB-donor (e.g., source IAB-donor 108A) for transmitting encrypted data to a UE (e.g., UE 102) via a target IAB-donor (e.g., target IAB-donor 108B) and an IAB-node (e.g., IAB-node 104).

At block 1102, a source IAB-donor connects to a UE via an IAB-node (e.g., in event 502). As such, the source IAB-donor can communicate data with the UE via the IAB-node. Later in time, a radio link failure on the connection between the source IAB-donor and IAB-node may occur. Consequently, the source IAB-donor can assist in establishing a radio connection between a target IAB-donor and the IAB-node.

Particularly, at block 1104, the source IAB-donor performs a Retrieve UE Context procedure with a target IAB-donor to transfer a context of the IAB-node to the target IAB-donor (e.g., in event 512). In response to the Retrieve UE Context procedure (e.g., in response to receiving a Retrieve UE Context Request message from the target IAB-donor), the source IAB-donor at block 1110 can perform a UE handover procedure to hand over the UE to the target IAB-donor so that the UE can communicate data with the target IAB-donor via the IAB-node. However, until the UE successfully hands over to the target IAB-donor, the UE can experience data interruption due to the occurrence of the radio link failure with the source IAB-donor.

To minimize or avoid data interruption, the source IAB-donor can communicate data with the UE via the IAB-node in the interim until the UE successfully hands over to the target IAB-donor. Because the source IAB-donor is unable to reach the IAB-node directly due to the radio link failure, the source IAB-donor can leverage the radio connection established between the target IAB-donor and the IAB-node. As such, at block 1106, the source IAB-donor encrypts data packet(s) for the UE, generates a PDU (e.g., PDCP PDU) including the encrypted data packet(s) (e.g., in event 503), and at block 1108, transmits the PDU to the UE via the target IAB-donor and the IAB-node (e.g., in events 505, 507, 509).

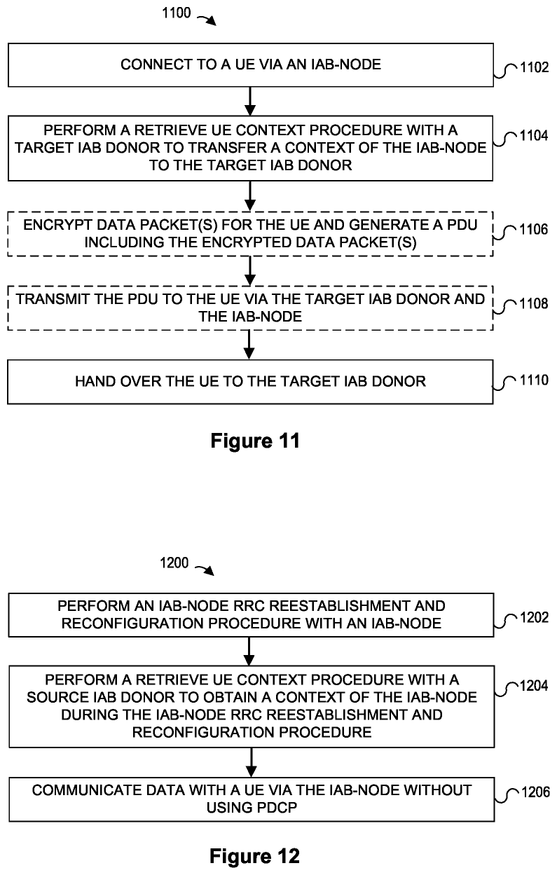

Referring now to FIG. 12, an example method 1200 can be implemented in a target IAB-donor (e.g., target IAB-donor 108B) for forwarding encrypted DL data received from a source IAB-donor (e.g., target IAB-donor 108B) to a UE (e.g., UE 102) via an IAB-node (e.g., IAB-node 104).

At block 1202, a target IAB-donor performs an IAB-node RRC reestablishment and reconfiguration procedure with an IAB-node (e.g., in event 590). In some implementations, the target IAB-donor performs the IAB-node RRC reestablishment and reconfiguration procedure with the IAB-node due to a radio link failure that occurs on a connection between a source IAB-donor and the IAB-node.

At block 1204, during the IAB-node RRC reestablishment and reconfiguration procedure, the target IAB-donor performs a Retrieve UE Context procedure with the source IAB-donor to obtain a context of the IAB-node (e.g., in events 510, 512).

As described above in FIG. 11, in some implementations, in response to the Retrieve UE Context procedure, the source IAB-donor can perform a UE handover procedure to hand over the UE to the target IAB-donor so that the UE can communicate data with the target IAB-donor via the IAB-node. To minimize or avoid data interruption until the UE successfully hands over to the target IAB-donor, the source IAB-donor can send a PDU (e.g., PDCP PDU) including encrypted DL data packet(s) to the UE. Because the source IAB-donor is unable to reach the IAB-node directly due to the radio link failure, the target IAB-donor can leverage its radio connection established with the IAB-node as a result of the IAB-node RRC reestablishment and reconfiguration procedure.

As such, at block 1206, the target IAB-donor can receive the PDU (e.g., PDCP PDU) from the source IAB-donor and forward the PDU (e.g., without applying any additional PDCP header on the PDCP PDU) to the UE via the IAB-node (e.g., in event 507).

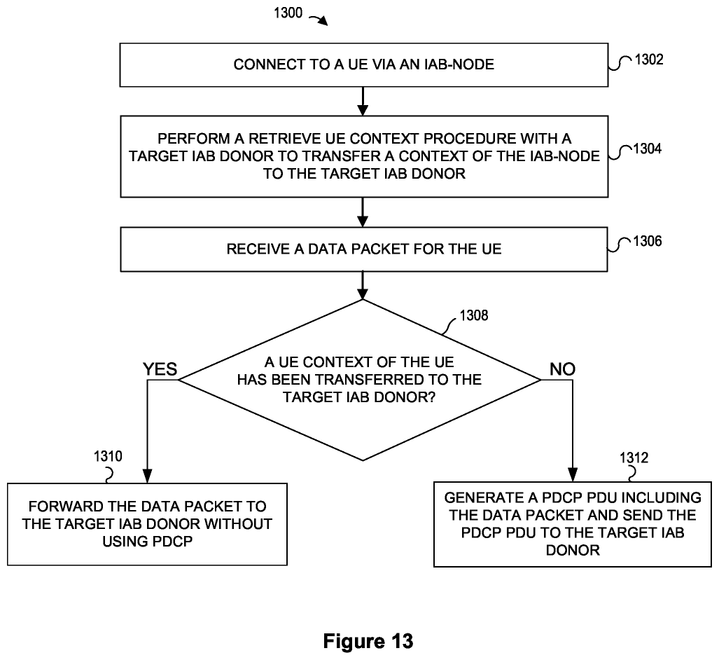

Referring now to FIG. 13, an example method 1300 can be implemented in a source IAB-donor (e.g., source IAB-donor 108A) for determining whether to apply PDCP to a DL data packet when transmitting data to a UE (e.g., UE 102) via a target IAB-donor (e.g., target IAB-donor 108B) and an IAB-node (e.g., IAB-node 104).

At block 1302, a source IAB-donor connects to a UE via an IAB-node, similar to block 1102, and at block 1304, performs a Retrieve UE Context procedure with a target IAB-donor to transfer a context of the IAB-node to the target IAB-donor, similar to block 1104.

Later on, at block 1306, the source IAB-donor may receive a DL data packet (e.g., from CN 110) for the UE and subsequently provide the DL data packet to the UE. As described above in FIGS. 5 and 6, the source IAB-donor can provide the DL data packet to the UE before the UE is successfully configured to communicate with the target IAB-donor (e.g., during a UE handover procedure 594 or a UE RRC reestablishment and reconfiguration procedure 698), or after the UE is successfully configured to communicate with the target IAB-donor. If the source IAB-donor provides the DL data packet to the UE before the UE is successfully configured to communicate with the target IAB-donor, the source IAB-donor sends the DL data packet in a DL PDU (e.g., PDCP PDU) to the target IAB-donor (e.g., in event 505), which in turn provides the DL PDU to the UE via the IAB-node. In contrast, if the source IAB-donor provides the DL data packet to the UE after the UE is successfully configured to communicate with the target IAB-donor, the source IAB-donor forwards DL data packet to the target IAB-donor (e.g., in events 544, 644), which in turn provides the DL data packet in a DL PDU (e.g., PDCP PDU) to the to the UE via the IAB-node.

As such, to determine whether to apply PDCP to the DL data packet when transmitting data to the UE via the target IAB-donor, the source IAB-donor at block 1308 determines whether a context of the UE has been transferred to the target IAB-donor. If the source IAB-donor at block 1308 determines that the context of the UE has been transferred to the target IAB-donor (e.g., in events 526, 660), the source IAB-donor at block 1310 forwards the DL data packet (e.g., without applying PDCP) to the target IAB-donor (e.g., in events 544, 644). If the source IAB-donor at block 1308 determines that the context of the UE has not been transferred to the target IAB-donor, the source IAB-donor at block 1312 applies PDCP to the DL data packet (e.g., DL PDCP PDU) and subsequently sends the DL PDCP PDU to the target IAB-donor (e.g., in events 505, 692).

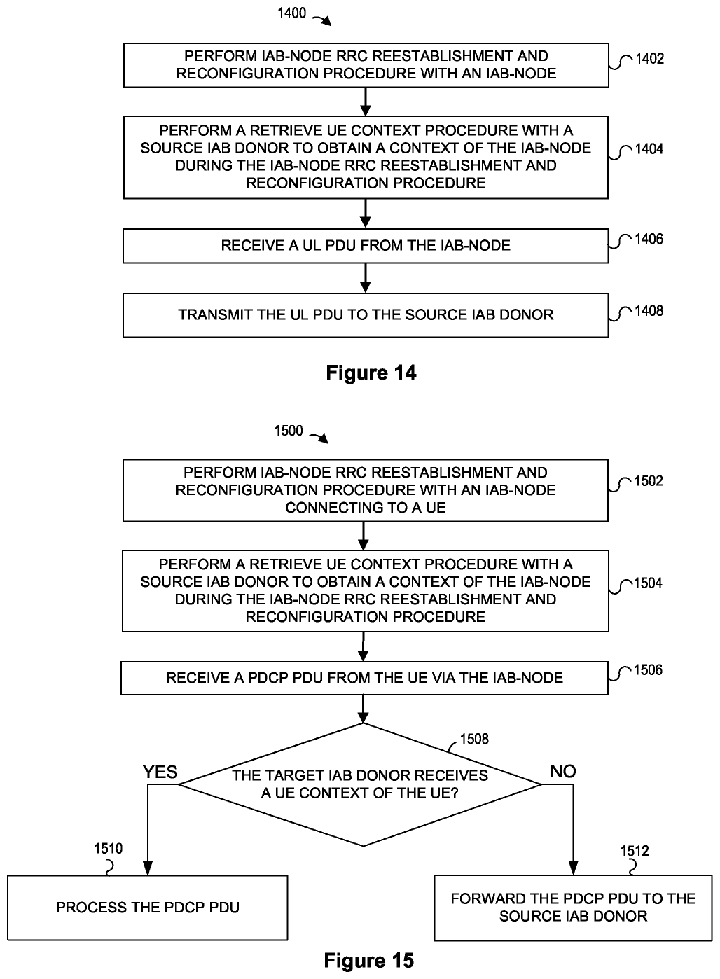

Referring now to FIG. 14, an example method 1400 can be implemented in a target IAB-donor (e.g., target IAB-donor 108B) for forwarding encrypted UL data received from a UE (e.g., UE 102) via an IAB-node (e.g., IAB-node 104) to a source IAB-donor (e.g., source IAB-donor 108A).

At block 1402, a target IAB-donor performs an IAB-node RRC reestablishment and reconfiguration procedure with an IAB-node, similar to block 1202, and at block 1404, during the IAB-node RRC reestablishment and reconfiguration procedure, performs a Retrieve UE Context procedure with the source IAB-donor to obtain a context of the IAB-node, similar to block 1204.

Whereas the target IAB-donor of FIG. 12 can provide DL data to the UE by receiving a DL PDU (e.g., DL PDCP PDU) from the source IAB-donor and forwarding the DL PDU (e.g., without applying any additional PDCP header on the DL PDCP PDU) to the UE via the IAB-node, the target IAB-donor of FIG. 14 can provide UL data encrypted by the UE to the source IAB-donor by receiving, at block 1406, a UL PDU (e.g., UL PDCP PDU) from the IAB-node (e.g., in event 517) and transmitting, at block 1408, the UL PDU to the source IAB-donor (e.g., in event 519).

Referring now to FIG. 15, an example method 1500 can be implemented in a target IAB-donor (e.g., target IAB-donor 108B) for determining whether to forward an encrypted UL data packet to a source IAB-donor (e.g., source IAB-donor 108A) or process (e.g., decrypt) the encrypted UL data packet after receiving the encrypted UL data from a UE (e.g., UE 102) via an IAB-node (e.g., IAB-node 104).

At block 1502, a target IAB-donor performs an IAB-node RRC reestablishment and reconfiguration procedure with an IAB-node, similar to block 1402, and at block 1504, during the IAB-node RRC reestablishment and reconfiguration procedure, performs a Retrieve UE Context procedure with the source IAB-donor to obtain a context of the IAB-node, similar to block 1404.

Later on, at block 1506, the target IAB-donor may receive an encrypted UL data packet (e.g., in a PDCP PDU) from the UE via the IAB-node. As described above in FIGS. 5 and 6, the target IAB-donor can forward the encrypted UL data packet to the source IAB-donor if the UE has not successfully been configured to communicate with the target IAB-donor (e.g., during a UE handover procedure 594 or a UE RRC reestablishment and reconfiguration procedure 698), or process (e.g., in event 537) the encrypted UL data packet if the UE has successfully been configured to communicate with the target IAB-donor.

As such, to determine whether to forward the encrypted UL data packet to the source IAB-donor or process the encrypted UL data packet, the target IAB-donor at block 1508 determines whether it has received a context of the UE. If the target IAB-donor at block 1508 determines that the context of the UE has been received (e.g., in events 526, 660), the target IAB-donor at block 1510 processes (e.g., decrypts) the encrypted UL data packet. If the target IAB-donor at block 1508 determines that the context of the UE has not been received, the target IAB-donor at block 1512 forwards the encrypted UL data packet to the source IAB-donor (e.g., in events 519, 692).

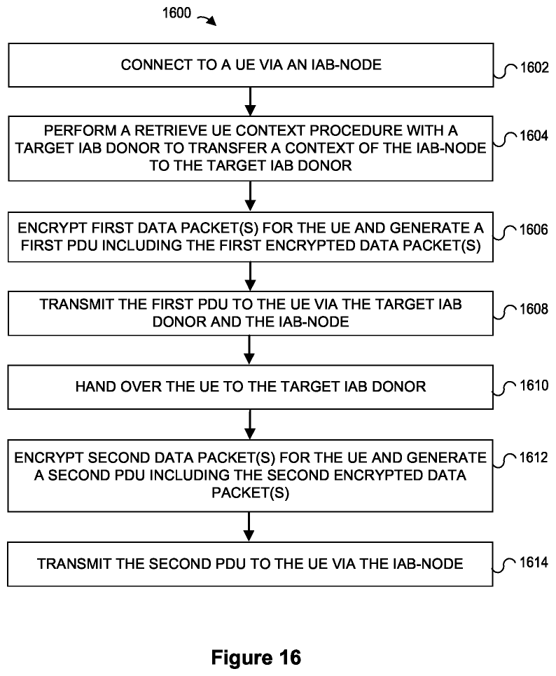

Referring now to FIG. 16, an example method 1600 can be implemented in a RAN (e.g., RAN 105) including an IAB-node (e.g., IAB-node 104), a source IAB-donor (e.g., source IAB-donor 108A), and a target IAB-donor (e.g., target IAB-donor 108B) for communicating with a UE (e.g., UE 102).

At block 1602, a source IAB-donor of the RAN connects to a UE via an IAB-node of the RAN, similar to block 1102. At block 1604, the source IAB-donor of the RAN performs a Retrieve UE Context procedure with a target IAB-donor of the RAN to transfer a context of the IAB-node to the target IAB-donor, similar to block 1104.

At block 1606, the source IAB-donor of the RAN encrypts first data packet(s) for the UE and generates a first PDU (e.g., PDCP PDU) including the first encrypted data packet(s), similar to block 1106. At block 1608, the source IAB-donor of the RAN transmits the first PDU to the UE via the target IAB-donor of the RAN and the IAB-node of the RAN, similar to block 1108.

At block 1610, in response to the Retrieve UE Context procedure (e.g., in response to receiving a Retrieve UE Context Request message from the target IAB-donor), the source IAB-donor of the RAN performs a UE handover procedure to hand over the UE to the target IAB-donor, similar to block 1110.

At block 1612, after the UE successfully hands over to the target IAB-donor, the target IAB-donor of the RAN encrypts second data packet(s) for the UE and generates a second PDU (e.g., PDCP PDU) including the second encrypted data packet(s) (e.g., in event 523). At block 1614, the target IAB-donor of the RAN transmits the second PDU to the UE via the IAB-node (without via the source IAB-donor) (e.g., in event 525).

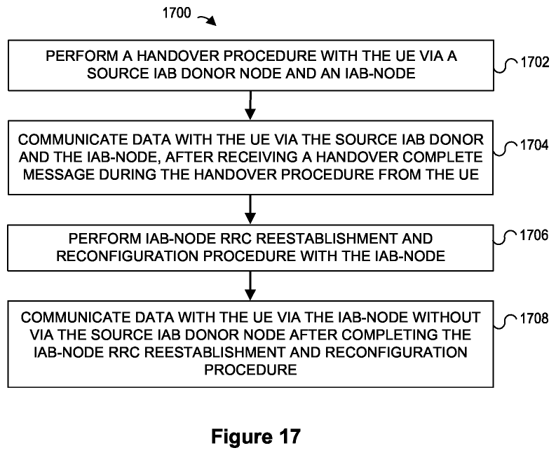

Referring now to FIG. 17, an example method 1700 can be implemented in a target IAB-donor (e.g., target IAB-donor 108B) for communicating with a UE (e.g., UE 102) via an IAB-node (e.g., IAB-node 104) after the UE hands over from a source IAB-donor (e.g., source IAB-donor 108A) to the target IAB-donor.

At block 1702, a target IAB-donor performs a handover procedure with a UE via a source donor IAB-node and an IAB-node (e.g., in event 795).

Upon completing the handover procedure (e.g., after receiving a Handover Complete message during the handover procedure from the UE), the target IAB-donor can communicate data with the UE via the source donor IAB-node and the IAB-node (e.g., in data communication procedure 797).

In some implementations, during the handover procedure, the source IAB-donor can determine that the IAB-node is to migrate from the source IAB-donor to establish a new radio connection with the target IAB-donor. As such, the target IAB-donor performs an IAB-node RRC reestablishment and reconfiguration procedure with the IAB-node at block 1706 (e.g., in event 790) to establish a connection between the IAB-node and the target IAB-donor. Until the target IAB-donor completes the IAB-node RRC reestablishment and reconfiguration procedure, the target IAB-donor at block 1704 can communicate data with the UE via the source IAB-donor and the IAB-node to minimize or avoid data interruption experienced by the UE as a result of the IAB-node migration.

Upon completing the RRC reestablishment and reconfiguration procedure, the target IAB-donor at block 1708 can communicate data with the UE via the IAB-node (without via the source IAB-donor).

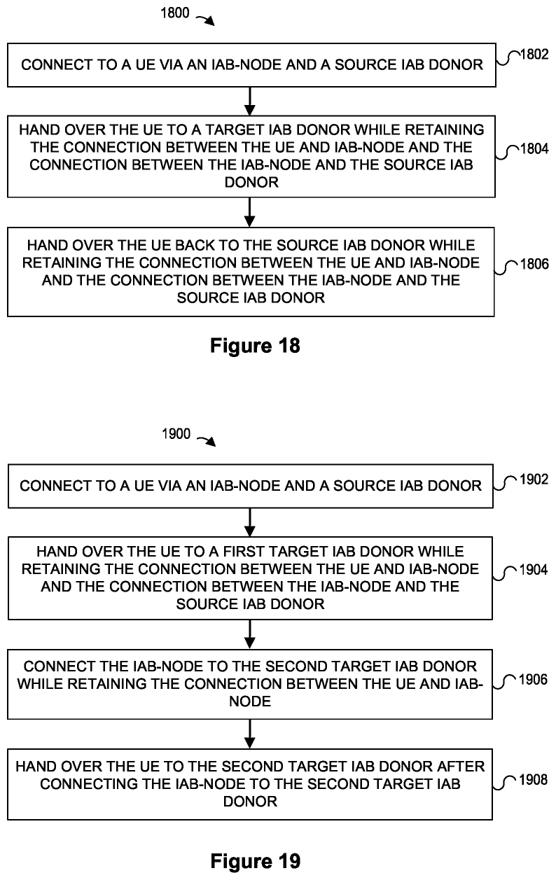

Referring now to FIG. 18, an example method 1800 can be implemented in a RAN (e.g., RAN 105) including an IAB-node (e.g., IAB-node 104), a source IAB-donor (e.g., source IAB-donor 108A), and a target IAB-donor (e.g., target IAB-donor 108B) for communicating with a UE (e.g., UE 102). Whereas the IAB-node of FIG. 17 establishes a connection with the target IAB-donor after the target IAB-donor performs a handover procedure to hand over the UE from the source IAB-donor to the target IAB-donor, the IAB-node of FIG. 18 establishes a connection with the source IAB-donor after the target IAB-donor performs a handover procedure to hand over the UE to the target IAB-donor. Accordingly, the RAN of FIG. 18 performs a handover procedure to hand over the UE from the target IAB-donor back to the source IAB-donor.

At block 1802, a RAN connects to a UE via an IAB-node and a source IAB-donor (e.g., in event 802).

At block 1804, the RAN performs a handover procedure to hand over the UE to a target IAB-donor while retaining the connection between the UE and the IAB-node, and the connection between the IAB-node and the source IAB-donor, similar to block 1702.

During the handover procedure, whereas the RAN of FIG. 17 performs an IAB-node RRC reestablishment and reconfiguration procedure with the IAB-node to establish a connection between the IAB-node and the target IAB-donor, the RAN of FIG. 18 may determine to perform an IAB-node RRC reestablishment and reconfiguration procedure with the IAB-node to establish a connection between the IAB-node and the source IAB-donor (e.g., in event 890).

Accordingly, the RAN at block 1806 performs a second handover procedure to hand over the UE back to the source IAB-donor while retaining the connection between the UE and the IAB-node, and the connection between the IAB-node and the source IAB-donor. Upon completing the second handover procedure, the RAN can communicate data with the UE via the IAB-node and the source IAB-donor.

Referring now to FIG. 19, an example method 1900 can be implemented in a RAN (e.g., RAN 105) including an IAB-node (e.g., IAB-node 104), a source IAB-donor (e.g., source IAB-donor 108A), a first target IAB-donor (e.g., target IAB-donor 108B), and a second target IAB-donor (e.g., target IAB-donor 108C) for communicating with a UE (e.g., UE 102). Whereas the IAB-node of FIG. 17 establishes a connection with the target IAB-donor after the target IAB-donor performs a handover procedure to hand over the UE from the source IAB-donor to the target IAB-donor, the IAB-node of FIG. 19 establishes a connection with a different target IAB-donor. Accordingly, the RAN of FIG. 19 performs a handover procedure to hand over the UE to the different target IAB-donor.

At block 1902, a RAN connects to a UE via an IAB-node and a source IAB-donor (e.g., in event 902).

At block 1904, the RAN performs a handover procedure to hand over the UE to a first target IAB-donor while retaining the connection between the UE and the IAB-node, and the connection between the IAB-node and the source IAB-donor, similar to block 1702.

During the handover procedure, whereas the RAN of FIG. 17 performs an IAB-node RRC reestablishment and reconfiguration procedure with the IAB-node to establish a connection between the IAB-node and the target IAB-donor, the IAB-node of FIG. 19 at block 1906 performs an IAB-node RRC reestablishment and reconfiguration procedure with the IAB-node to establish a connection between the IAB-node and a different target IAB-donor (i.e., a second target IAB-donor) while retaining the connection between the UE and the IAB-node (e.g., in events 990, 1090).

After connecting the IAB-node to the second target IAB-donor, the RAN at block 1908 performs a second handover procedure to hand over the UE to the second target IAB-donor. Upon completing the second handover procedure, the RAN can communicate data with the UE via the IAB-node and the second target IAB-donor.

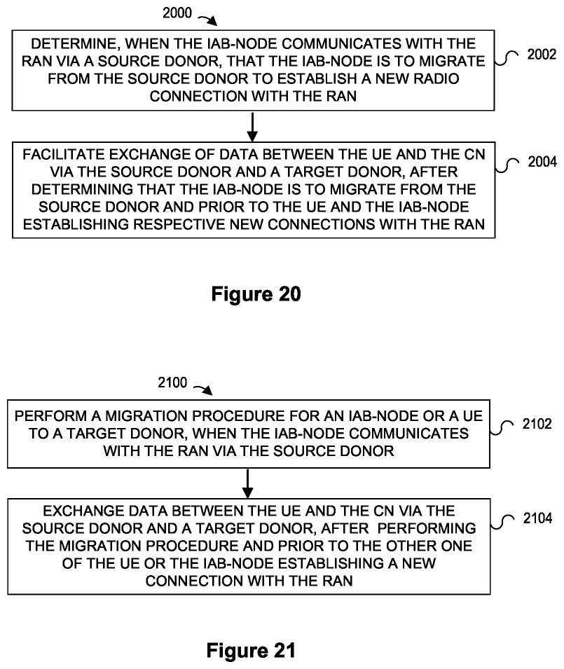

Referring now to FIG. 20, an example method 2000 can be implemented in a source donor (e.g., source IAB-donor 108A) for managing a connection between a UE (e.g., UE 102) and a RAN (e.g., RAN 105) via an IAB-node (e.g., IAB-node 104).

At block 2002, a source donor determines, when an IAB-node communicates with a RAN via the source donor, that the IAB-node is to migrate from the source donor to establish a new radio connection with the RAN (e.g., in events 510, 690, 704, 804, 904, 1004). In some implementations, the source donor performs the determination in response to receiving, from a target donor (e.g., target IAB-donor 108B), a request for a context of the IAB-node (e.g., in events 510, 610). In other implementations, the source donor performs the determination in response to determining to initiate a handover of the UE to the target donor based on signaling between the source donor and the IAB-node (e.g., in events 704, 804, 904, 1004).

At block 2004, subsequently to the determining and prior to the UE and the IAB-node establishing respective new connections with the RAN (e.g., in events 594, 698, 790, 863, 963, 1063), the source donor facilitates exchange of data between the UE and a CN (e.g., CN 110) via the source donor and the target donor (e.g., in events 592, 692, 797, 897, 997, 1097). In some implementations, the source donor forwards, to the target donor, DL data received from the CN and addressed to the UE (e.g., in events 505, 692). The source donor can encrypt the DL data prior to forwarding the DL data to the target donor (e.g., in event 503). In other implementations, the source donor receives encrypted UL data from the UE via the target donor and decrypts the UL data (e.g., in event 521).

Referring now to FIG. 21, an example method 2100 can be implemented in a target donor (e.g., target IAB-donor 108B) for managing a connection between a UE (e.g., UE 102) and a RAN (e.g., RAN 105) via an IAB-node (e.g., IAB-node 104).

At block 2102, a target donor performs, when an IAB-node communicates with a RAN via a source donor (e.g., source IAB-donor 108A), a migration procedure for one of the IAB-node or a UE to the target donor (e.g., in events 590, 690, 795, 895, 995, 1095). In some implementations, the migration procedure is a random access procedure initiated by the IAB-node (e.g., in events 506, 690). In other implementations, the migration procedure is a handover procedure for the UE (e.g., in events 795, 895, 995, 1095).

At block 2104, subsequently to the performing and prior to the other one of the UE or the IAB-node establishing a new connection with the RAN (e.g., in events 594, 698, 790, 899, 999, 1099), the target donor exchanges data between the UE and a CN (e.g., CN 110) via the source donor and the target donor (e.g., in events 592, 692, 797, 897, 997, 1097). In implementations in which the migration procedure is a random access procedure initiated by the IAB-node, the target donor forwards, to the IAB-node, DL data received from the source donor and addressed to the UE (e.g., in events 507, 692). The target donor can also forward, to the source donor, UL data received from the UE via the IAB-node (e.g., in events 519, 692). In implementations in which the migration procedure is a handover procedure for the UE, the target donor transmits, to the source donor, DL data received from the CN and addressed to the UE. The target donor can encrypt the DL data prior to transmitting the DL data to the source donor (e.g., in events 723, 897, 997, 1097). The target donor can also receive UL data from the UE via the source donor (e.g., in events 735, 897, 997, 1097), and subsequently decrypt the UL data using a security context for the UE (e.g., in events 723, 897, 997, 1097).

The following additional considerations apply to the foregoing discussion.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for managing UE connections during or after IAB topology change through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

Aspect 1. A method in a source donor for managing a connection between a user equipment (UE) and a radio access network (RAN) via an integrated access backhaul (IAB)-node, the method comprising: determining, by processing hardware and when the IAB-node communicates with the RAN via the source donor, that the IAB-node is to migrate from the source donor to establish a new radio connection with the RAN; subsequently to the determining and prior to the UE and the IAB-node establishing respective new connections with the RAN: facilitating, by the processing hardware, exchange of data between the UE and a core network (CN) via the source donor and a target donor.

Aspect 2. The method of aspect 1, wherein the determining includes: receiving, from the target donor, a request for a context of the IAB-node, the context associated with a protocol for controlling radio resources.

Aspect 3. The method of aspect 2, further comprising: transmitting, by the processing hardware and in response to the request for the context, the context of the IAB-node to the target donor.

Aspect 4. The method of aspect 2 or 3, further comprising: transmitting, by the processing hardware and in response to the request for the context, security information of the IAB-node to the target donor.

Aspect 5. The method of any of aspects 2-3, wherein the facilitating includes: forwarding, by the processing hardware to the target donor, downlink data received from the CN and addressed to the UE.

Aspect 6. The method of aspect 5, wherein the forwarding includes: encrypting, by the processing hardware, the DL data packets, in accordance with a context of the UE.

Aspect 7. The method of any of aspects 2-6, wherein the facilitating includes: decrypting, by the processing hardware, uplink data received from the UE via the target donor.

Aspect 8. The method of any of aspects 5, wherein the forwarding includes: determining whether a context of the UE had been transferred to the target donor; in a first instance, in response to determining that the context of the UE had not been transferred, generating a Packet Data Convergence Protocol (PDCP) protocol data unit (PDU) including the downlink data, prior to the forwarding; and in a second instance, in response to determining that the context of the UE had been transferred, forwarding the downlink data without generating a PDCP PDU.

Aspect 9. The method of any of aspects 2-8, further comprising, subsequently to receiving the request for the context of the IAB-node: transmitting, by the processing hardware to the target donor, a handover request for the UE.

Aspect 10. The method of any of aspects 2-8, further comprising, subsequently to receiving the request for the context of the IAB-node: receiving, from the target donor, a request for a context of the UE, the context associated with a protocol for controlling radio resources.

Aspect 11. The method of aspect 1, wherein the determining includes: determining, by processing hardware and based on signaling between the source donor and the IAB-node, to initiate a handover of the UE to the target donor.

Aspect 12. The method of aspect 11, further comprising: transmitting, by the processing hardware to the target donor, a handover request for the UE.

Aspect 13. The method of aspect 11 or 12, wherein the facilitating includes: transmitting, by the processing hardware, downlink data received from the target donor to the UE.

Aspect 14. The method of any of aspects 11-13, further comprising: subsequently to transmitting the handover request, performing a radio resource control (RRC) reestablishment procedure for connecting the IAB-node to the source donor.

Aspect 15. The method of aspect 14, further comprising: in response to completing the RRC reestablishment procedure, transmitting, by the processing hardware to the target donor, a handover indication related to the IAB-node.

Aspect 16. The method of aspect 14 or 15, further comprising: subsequently to completing the RRC reestablishment procedure, receiving, by the processing hardware from the target donor, a handover request for the UE, for handing the UE over to the source donor.

Aspect 17. The method of any of aspects 11-13, wherein: the target donor is a first target donor; the method further comprising: subsequently to (i) the handover of the UE to the target donor and (ii) the IAB-node performing an RRC reestablishment procedure for connecting the IAB-node to a second target donor, forwarding downlink data received from the first target donor to the second target donor.

Aspect 18. The method of aspect 17, further comprising: receiving, by the processing hardware from the first target donor, a handover request for the UE, handover request related to the second target donor.

Aspect 19. The method of any of the preceding aspects, further comprising: transmitting, by the processing hardware to the target donor, a message indicating an uplink Packet Data Convergence Protocol (PDCP) sequence number (SN) and a downlink PDCP SN for a data radio bearer (DRB) used by the UE.

Aspect 20. A method in a target donor for managing a connection between a user equipment (UE) and a radio access network (RAN) via an integrated access backhaul (IAB)-node, the method comprising: performing, by processing hardware and when the IAB-node communicates with the RAN via a source donor, a migration procedure for one of the IAB-node or the UE to the target donor; subsequently to the performing and prior to the other one of the UE or the IAB-node establishing a new connection with the RAN: exchanging, by the processing hardware, data between the UE and a core network (CN) via the source donor and the target donor.

Aspect 21. The method of aspect 20, wherein performing the migration procedure includes: performing, by the processing hardware, a random access procedure initiated by the IAB-node.

Aspect 22. The method of aspect 21, further comprising: transmitting, by the processing hardware and to the source donor, a request for a context of the IAB-node, the context associated with a protocol for controlling radio resources.

Aspect 23. The method of aspect 22, further comprising: receiving, by the processing hardware and from the source donor, the context of the IAB-node, the context including security information of the IAB-node.

Aspect 24. The method of any of aspects 20-23, further comprising: performing, by the processing hardware, an F1 setup procedure with the IAB-node to establish a connection via an F1 interface.

Aspect 24. The method of any of aspects 21-23, wherein the exchanging includes: forwarding, by the processing hardware to the IAB-node, downlink data received from the source donor and addressed to the UE.

Aspect 25. The method of any of aspects 21-24, wherein the exchanging includes: forwarding, by the processing hardware to the source donor, uplink data received from the UE via the IAB-node.

Aspect 26. The method of any of aspects 20-25, further comprising, subsequently to performing the migration procedure: receiving, by the processing hardware and from the source donor, a handover request for the UE.

Aspect 27. The method of aspect 26, further comprising: in response to the handover request, transmitting, by the processing hardware to the IAB-node, a request for a context of the UE.

Aspect 28. The method of any of aspects 20-25, further comprising, subsequently to performing the migration procedure: performing an RRC reestablishment procedure for the UE.

Aspect 29. The method of aspect 28, wherein performing the RRC reestablishment procedure for the UE includes: transmitting, by the processing hardware and to the source donor, a request for a context of the UE, the context associated with a protocol for controlling radio resources.

Aspect 30. The method of aspect 20, wherein performing the migration procedure includes: performing, by the processing hardware, a handover procedure for the UE, including obtaining a security context for the UE.

Aspect 31. The method of aspect 30, wherein the exchanging includes: transmitting, by the processing hardware to the source donor, downlink data received from a core network (CN) and addressed to the UE.

Aspect 32. The method of aspect 31, wherein the exchanging includes: encrypting the downlink data using the security context for the UE.

Aspect 33. The method of aspect 31 or 32, wherein the exchanging includes: receiving, by the processing hardware, uplink data from the UE via the source donor.

Aspect 34. The method of any of aspects 31-33, wherein the exchanging includes: decrypting the uplink data using the security context for the UE.

Aspect 35. The method of any of aspects 30-34, further comprising: performing, by the processing hardware, an RRC reestablishment procedure for the IAB-node.

Aspect 36. The method of any of aspects 30-34, further comprising: determining, subsequently to performing the handover procedure for the UE, to initiate a handover of the UE back to the source donor.

Aspect 37. The method of any of aspects 30-34, further comprising: receiving, subsequently to performing the handover procedure for the UE, a handover indication related to the UE, from a second target donor.

Aspect 38. The method of aspect 37, further comprising: transmitting, in response to the handover indication to the second target donor, a handover request for the UE.

Aspect 39. A donor in an integrated access backhaul (IAB) topology of a radio access network (RAN), the donor including processing hardware and configured to implement a method of any the preceding aspects.

1. A method in a source donor for managing a connection between a user equipment (UE) and a radio access network (RAN) via an integrated access backhaul (IAB)-node, the method comprising:
determining, by the source donor and when the IAB-node communicates with the RAN via the source donor, that the IAB-node is to migrate from the source donor to a target donor to establish a new radio connection with the RAN;
based on the determining, establishing, by the source donor, connectivity with the target donor;
subsequently to the establishing, receiving, by the source donor and from a core network (CN), a downlink (DL) data packet addressed to the UE; and
facilitating, by the source donor and via the target donor, communication of the DL data packet to the UE after migrating the IAB-node to the target donor.

2. The method of claim 1, wherein the determining includes:
receiving, from the target donor, a request for a context of the IAB-node, the context associated with a protocol for controlling radio resources.

3. The method of claim 2, further comprising:
transmitting, by the source donor and in response to the request for the context, the context of the IAB-node to the target donor.

4. The method of claim 3, wherein the facilitating includes forwarding, by the source donor, the DL data packet to the target donor prior to the transmitting of the context of the IAB-node to the target donor.

5. The method of claim 2, further comprising, subsequently to receiving the request for the context of the IAB-node:
transmitting, by the source donor to the target donor, a handover request for the UE.

6. The method of claim 2, further comprising, subsequently to receiving the request for the context of the IAB-node:
receiving, from the target donor, a request for a context of the UE, the context associated with a protocol for controlling radio resources.

7. The method of claim 1, wherein the facilitating includes:
encrypting, by the source donor, the DL data packet in accordance with a context of the UE.

8. The method of claim 1, further comprising, subsequently to the establishing:
receiving, by the source donor and from the target donor, an uplink (UL) data packet transmitted by the UE and forwarded to the source donor from the target donor; and
decrypting, by the source donor, the uplink data packet.

9. The method of claim 1, wherein the determining includes:
determining, by the source donor and based on signaling between the source donor and the IAB-node, to initiate a handover of the UE to the target donor.

10. The method of claim 9, further comprising:
transmitting, by the source donor to the target donor, a handover request for the UE.

11. A method in a target donor for managing a connection between a user equipment (UE) and a radio access network (RAN) via an integrated access backhaul (IAB)-node, the method comprising:
performing, by the target donor and when the IAB-node communicates with the RAN via a source donor, a migration procedure for one of the IAB-node or the UE to the target donor; and
after a completion of the migration procedure:
receiving, by the target donor and from the source donor, a downlink (DL) data packet addressed to the UE; and
forwarding, by the target donor, the DL data packet to the IAB-node.

12. The method of claim 11, wherein performing the migration procedure includes performing, by the target donor, a random access procedure initiated by the IAB-node.

13. The method of claim 12, further comprising:
transmitting, by the target donor and to the source donor, a request for a context of at least one of the UE or the IAB-node, the context associated with a protocol for controlling radio resources; and
receiving, by the target donor and from the source donor, the context of the at least one of the UE or the IAB-node,
wherein the forwarding of the DL data packet occurs prior to the receiving of the context of the at least one of the UE or the IAB-node.

14. The method of claim 13, wherein
the context includes security information of the at least one of the UE or the IAB-node.

15. A donor in an integrated access backhaul (IAB) topology of a radio access network (RAN), the donor including processing hardware and configured to implement the method of claim 1.

16. A donor in an integrated access backhaul (IAB) topology of a radio access network (RAN), the donor including processing hardware and configured to implement the method of claim 11.
